(19) United States
(12) Patent Application Publication
(10) Pub. No.: US 2017/0308926 A1
(43) Pub. Date: Oct. 26, 2017

(54) ARRANGEMENTS FOR FACILITATING e-COMMERCE VIA A MESSAGING SERVICE WITH SEEMLESS TRANSITION TO AN IP BASED SERVICE

(71) Applicants: Michael R. Wofford, Elkhorn, NE (US); Daniel J. Casson, Council Bluffs, IA (US)

(72) Inventors: Michael R. Wofford, Elkhorn, NE (US); Daniel J. Casson, Council Bluffs, IA (US)

(21) Appl. No.: 15/647,973

(22) Filed: Jul. 12, 2017

Related U.S. Application Data
(63) Continuation-in-part of application No. 13/309,876, filed on Dec. 2, 2011, now abandoned.
(60) Provisional application No. 61/426,807, filed on Dec. 23, 2010.

(51) Int. Cl. G06Q 30/02; G06Q 20/04; G06Q 20/40; G06Q 30/00

(52) U.S. Cl. CPC G06Q 30/0245; G06Q 20/40; G06Q 20/04; G06Q 30/00

(57) ABSTRACT

Configurations for facilitating electronic commerce are disclosed. In some embodiments, a retailer/non-profit entity (“provider”) sends content and offer and a selectable link to prospective consumers via a messaging service. The offer is sufficiently defined such that a consumer's selection of the link provides a preliminary acceptance to the provider's offer. A consumer's acceptance to the provider offer can be received by a front-end commerce application (FECA) and the FECA can reply via the messaging service with a shortened unique universal resource locator (URL) for selection by the consumer where upon selection of this URL will seamlessly place the consumer in communication with their funding source of choice. Such a configuration efficiently bridges communication between a messaging service and an Internet Protocol service allowing ad-hoc access to a transaction account via simple link selections by a consumer in response to an advertising impression.

### CROSS-REFERENCE TO PRIOR PATENT APPLICATION

This application is a Continuation-in-Part of U.S. patent application Ser. No. No 13/309,876, entitled “ARRANGEMENTS FOR FACILITATING e-COMMERCE VIA A TEXT BASED NETWORK,” filed on Dec. 2, 2011, which claims priority under 35 U.S.C. §119(e) of U.S. Provisional Patent Application Ser. No. 61/426,807, entitled “System and Method for Advertising, Selling and Tracking Consumer Activity Via a SMS Network,” which was filed on Dec. 23, 2010, the disclosure of which is incorporated by reference herein in its entirety.

### FIELD OF INVENTION

This disclosure generally relates to interacting with specialized servers to conduct a transaction and more particularly to conducting at least a portion of e-commerce transaction via a Messaging Service NS) such as a Simple Messaging Service (SMS) or a Multimedia Messaging Service (MMS) and seamlessly transitioning the process to a web browser interface such that the transaction can be completed over an IP based network without a consumer having to download and execute financial transaction applications on their smartphone computer, or interface device. More specifically, this disclosure relates to the facilitation of an interactive e-commerce campaign by a provider, where a consumer exposed to an advertisement can easily and efficiently respond to an advertisement to complete a transaction where each provider using the disclosed arrangements can tailor system operations to meet their needs for different campaigns which provides a pleasurable experience for consumers.

### BACKGROUND

Entities (herein referred to as “providers”) advertise and market their product goods and services) to consumers in an attempt to persuade prospective consumers (i.e., audience, viewers, readers, listeners, users, etc.) to donate money, use their services of purchase their advertised product. Different types of media outlets can be utilized to deliver these advertisements (ads), including traditional media outlets such as newspapers, magazines, television, radio, outdoor signage, and direct mail to name a few. More recently, additional media outlets such as websites and mobile communication devices have emerged as media outlets or vehicles to get ads to, prospective consumers. Currently, it is difficult, if not impossible, for an advertiser to accurately predict exposure to consumers and to predict audience reaction or audience behavior resulting, from a particular ad or ad campaign.

Pull advertising or pull marketing refers to efforts of a provider or advertiser to get an ad out to a large group of potential customers in an attempt to expose customers to the ad who are likely interested in the offering. Most traditional or offline media outlets as well as many online ads can be considered pull advertising as the content is intended to pull prospective consumers to the offering. Push advertising, on the other hand, target marketing which is more tailored or consumer focused and generally attempts to push or lure potential customers from a known or targeted pool of consumers into purchasing a particular offering. In pull type advertising, the advertiser will likely have data or know something about the targeted audience. For example, the target audience might be past customers, persons who have expressed interest in the product, or persons who have a relationship with the advertiser or are in some other way known to the advertiser. Examples of pull advertising campaign processes can include communications sent to a known address of a user such as an email address, a phone number, a social media handle, or a physical address.

Traditionally, a consumer will be exposed to an advertisement and even if the consumer wants the advertised product, considerable time will pass before the consumer can physically react to or respond to the advertisement. For example, a consumer seeing a billboard, hearing a radio commercial, or seeing a television commercial must find time to visit a retail location in person, call a retailer, mail in an order form, or go to a specified website to initiate a transaction to obtain the advertised product or service. The methods that allow for a consumer to make a timely, in the moment response to an impressionable advertisement (ad) when they desire to purchase the advertised product and/or service are less than perfect. In addition to this inefficiency, traditional ad-purchase cycles require a retailer to have and maintain expensive real estate, storefronts, and/or staff.

### SUMMARY OF THE INVENTION

Disclosed herein are configurations for setting up and facilitating transactions between a provider and a consumer. Such transactions can include the process of developing and testing a tailored campaign for: managing aspects of a political campaign and other non-profit organization tasks, marketing, advertising, selling, delivering, servicing, paying, monitoring and managing a campaign that can be operated via an electronic communication system such as messaging systems, the Internet, and other computer networks. However, the disclosed arrangements may also include a broader range of technologies such as e-mail, mobile devices, and telephones as well. The configurations can include storing data related to the distribution of advertising content to consumers via at least one media outlet.

In some embodiments, content published by a provider can have a message response facilitator (i.e., telephone number, keyword or short code or combination thereof) useable by a message system NS) which provides a direct reply path for the consumer, such that a consumer, via a consumer interface device (CID), can respond to an impression created by the advertising content where the consumer is quickly and efficiently connected to the transaction account or preferred financial account. Using the reply link, a consumer requests access to their transaction account to facilitate a donation or purchase for the advertised product. Some configurations can monitor the response communication from the CID via the reply path. The disclosed embodiments can facilitate the transmission of a selectable link to the CID and the selectable link when activated by the consumer will place the CID in communication with a front-end commerce application (FECA), which connects to the consumer's transaction account via a transaction account authentication entity. The selectable link could be a Universal Resource Locator (URL) accessible via the Internet Protocol format.

In some embodiments, the method can include storing data related to the distribution of ad content to consumer via at least one media outlet, the content having a message response facilitator useable by a text based message system (MS), the ad/marketing text campaign application to provide a reply path such that a consumer via a CID responds to an impression created by the ad content, and automatically requests access to a transaction account. The disclosed configurations can monitor a response communication from the CID via the reply path and can facilitate the transmission of a selectable link to the CID. When the link is activated, it automatically places the CID in communication with a front-end commerce application using a seamless, communication Internet Protocol format path such as those used by 4G and 5G telecommunications networks. The e-commerce front-end application can place the CID in communication with a transaction account authentication entity. The communication can include a request for information related to a transaction account associated with the CID. The disclosed embodiments can further accept a consumer's reply to a purchase acknowledgement request and send an authorization status message to the consumer based on a response from a transaction account authorization entity.

In some embodiments, a targeted ad with a reply link is presented to a consumer where the link defines a reply path to a FECA server which can be utilized to initiate and complete an e-commerce transaction to give a donation, sign up for an activity, or acquire an advertised product or service via simple entries by a consumer on their CID. The consumer can complete the transaction using their CID without having to download or locally execute software from an entity conducting a financial transaction with a third-party entity such as a gateway provider, a transaction processor, or a transaction authorization entity.

Another embodiment provides a machine-accessible medium or computer useable medium containing instructions effective, when executing in a data processing system, to cause the system to perform a series of operations where consumers, exposed to an advertisement, can utilize a secure MS communication link via a CID to respond to a reply path provided by an advertisement to facilitate or conduct an e-commerce transaction. The disclosed system can offer a consumer the opportunity to immediately and conveniently respond to a visual or audio ad and conduct a near real time e-commerce transaction immediately upon getting an impression or after seeing ad from any location where a telecommunication service is available.

### BRIEF DESCRIPTION OF THE DRAWINGS

Advantages of the disclosed embodiments will become apparent upon reading the following detailed description and upon reference to the accompanying drawings:

FIG. 1 is a block diagram depicting a pull type ad/marketing embodiment;

FIG. 2 is a flow diagram that illustrates a pull type ad/marketing embodiment;

FIG. 3 is a block diagram depicting a push type ad/marketing embodiment;

FIG. 4 is a block diagram illustrating a subscriber opt-in or registration arrangement for a push type ad/marketing campaign embodiment;

FIG. 5 is a depiction of a web page based graphical user interface that can be utilized by a provider to set up and configure a campaign that can be utilized to solicit consumers and accept payments from consumers;

FIG. 6 is a block diagram depicting how executable code modules and file systems can be configured to communicate with one another to facilitate system operation;

FIG. 7A is a communication flow diagram showing aspects of the communication process between various hardware and software modules of the current disclosure;

FIG. 7B is a continuation of the communication flow diagram of FIG. 7A;

FIG. 8A is a communication flow diagram showing aspects of a provider's donation type campaign;

FIG. 8B is a continuation of the communication flow diagram of FIG. 8A;

FIG. 8C is a continuation of the communication flow diagram of FIG. 8B;

FIG. 8D is a continuation of the communication flow diagram of FIG. 8C;

FIG. 8E is a continuation of the communication flow diagram of FIG. 8D;

FIG. 9A is a communication flow diagram showing aspects of an e-commerce transaction process that can be facilitated by the disclosed embodiments;

FIG. 9B is a continuation of the communication flow diagram of FIG. 9A; and

FIG. 9C is a continuation of the communication flow diagram of FIG. 9B.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments: on the contrary, the intention is to cover all modifications, equivalents, and alternatives falling within the spirit and scope of the present invention as defined by the appended claims. In the following description, like reference characters designate like or corresponding parts throughout the figures. Additionally, in the following description, it is understood that terms such as “first,” “second.” and the “like” are words of convenience and are not to be construed as limiting terms.

It can be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without one or more of these specific details. In other instances, well-known methods, procedures, and components have not been described in detail so as not to obscure the embodiments described herein. Also, the description provided is not to be considered as limiting or limited to the exact scope of the embodiments described herein.

It can be appreciated by those with skill in the art that currently there is no effective and efficient way to accurately monitor, quantify, relate, and estimate the success or failure of an advertising or marketing campaign or determine how many people were targeted or were exposed to an ad, and how many people who, as a result of the exposure, actually responded to and/or initiated and/or completed an e-commerce transaction or took some other action. Currently, adverting metrics require many assumptions and calculations and are merely estimates provided by many variables. More specifically, audience reaction and behavior in response to an ad, or ad campaign, depends on many factors such as the content of the ad, the type of media outlet utilized, the classification or type of consumer/audience the content reaches, the duration and time of day an ad runs, the type of targeting the campaign uses, and useable data that effectively relates the above variables to a success metrics.

Recently there has been a proliferation of the consumer communication devices all over the world. Penetration and rate of penetration of the mobile phones in the United States has surpassed cable television, web access, and personal computers (PCs) in terms of users. Wireless devices are becoming ubiquitous as today; most consumers in the US own smartphones or other wireless devices and carry such a device wherever they go. As a result, providers of goods and services have developed an ever-increasing appetite for exploring new options or ways to reach prospective consumers carrying such devices. The disclosed embodiments provide a simple seamless way to effectuate commerce via reaching consumers via current communication devices. The disclosed arrangements provide an ad-hoc communication systems and methods which is very easy and convenient for a provider to set up and manage and very easy and convenient for a consumer to utilize. The disclosed embodiments allow for a consumer to make mobile payments with simple single-entry responses to well-defined offers or solicitations and acknowledgements which can then be utilized to access an account and make a financial transaction.

It can be appreciated that advertisers and transaction account authorizing entities operate with two separate and distinct business models and corresponding technology silos. The present invention facilitates bridging these silos, i.e., bridging mobile advertising with transaction account management via a FECA server using simple inputs from a smartphone or CID. The teachings herein provide efficient, effective, and robust configurations that allow a provider to directly configure then monetize an ad by offering the consumer an immediate connection for purchase where a consumer can, in the moment, connect a provider's offering with their financial transaction account to complete a transaction. Methods and processes utilized by providers of goods and/or services to market, advertise, and sell their offerings are continually changing with the proliferation of ever improving communication devices and software.

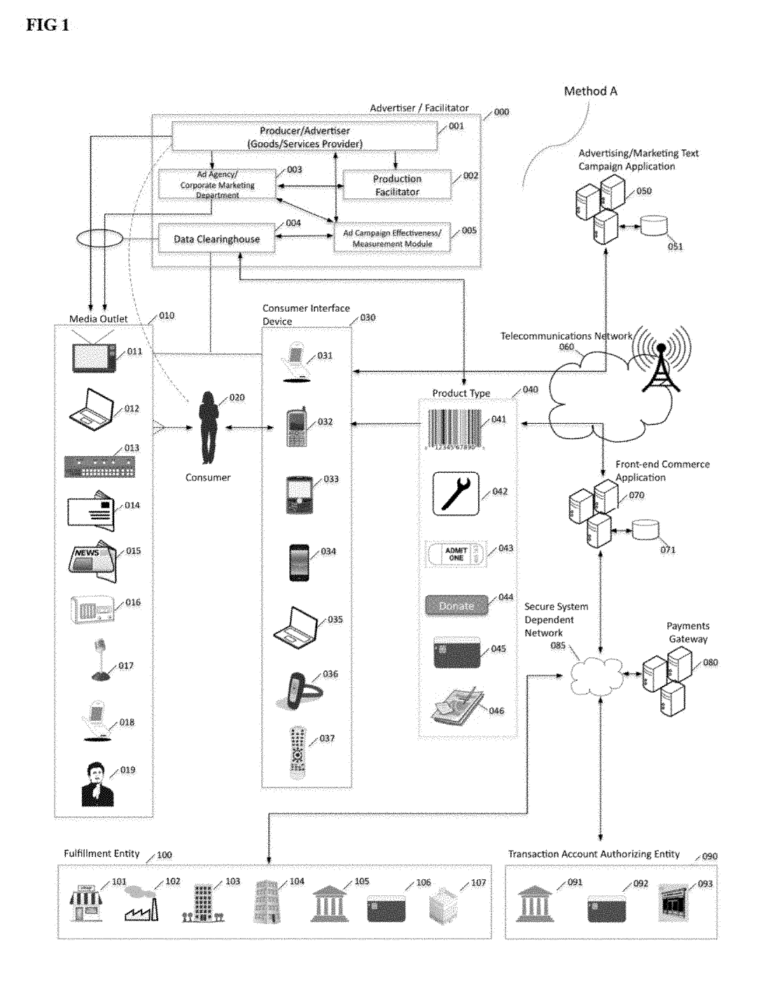

Referring to FIG. 1, the system can include an advertiser/facilitator 000, media outlet 010, consumer 020. consumer interface device (CID) 030, product type 040, ad/marketing text campaign application 050, telecommunications network 060, front-end commerce application (FECA) 070, payments gateway 080, secure system dependent network (SSDN) 085, transaction account authorizing entity (TAAE) 090, and fulfillment entity 100. In some embodiments, configurations for e-commerce are disclosed. In some embodiments, data related to the distribution of ad content to consumer 020, via at least one media outlet, can be acquired and stored. The content can include a message response facilitator (MRF) such as a specific telephone number or a short code for use by the consumer 020 to reply and indicate interest in the advertised product. The message response facilitator useable by a text based message system (MS) can provide a reply path such that a consumer 020, via a CID 030, can select the reply path to conduct an e-commerce transaction to acquire the product. The disclosed configuration can monitor a response communication from the CID 030 and facilitate transmission of a selectable link to the CID 030.

The reply path when activated can place the CID 030 in communication with a FECA 070 where the communication can include the e-commerce transaction request consisting of information such as the purchase quantity, amount, delivery, etc., the consumer's transaction account details, and a reply to the request consisting of information such as the transaction account authorization status from a TAAE 090 and/or fulfillment entity 100. A consumer 020 can access a transaction account without downloading a proprietary financial transaction application and executing such an application on the CID 030. Consumer 020 activities performed in response to the impression made by the ad content can be stored, analyzed, and used to improve the effectiveness of future ad campaigns.

In some embodiments, ad content with a textual component with a reply path is distributed via an ad/marketing text campaign system 050 to a consumer 020. The consumer 020, via a CID 030, can select the reply path to conduct an e-commerce transaction to acquire the advertised product. The reply path when activated can place the CID 030 in communication with FECA application 070 where the communication can include the e-commerce transaction request consisting of information such as the purchase quantity, amount, delivery, etc., the consumer's transaction account details, and a reply to the request information consisting of information such as the transaction account authorization status from a TAAE 090 and/or fulfillment entity 100. A consumer 020 can access a transaction account without downloading a proprietary financial transaction application and executing such an application on the CID 030. Consumer 020 activities performed in response to the impression made by the ad content can be stored, analyzed, and used to improve the effectiveness of future ad campaigns.

In some embodiments, the system can identify media outlets associated with the ad content and acquire and store consumer 020 activity data based on the consumer's 020 response to the ad content. The consumer 020 activity data can be organized and analyzed to create metadata about the system and consumer 020 activity. In some embodiments, the response code is a simple short code or keyword that is unique to a specific entity and can be tailored to the consumer's 020 interface device. In addition, data associated with the e-commerce transaction can be sent to a fulfillment entity associated with a producer/provider associated with the advertisement. Authorizing against a consumer's transaction account can include one of an approval or a denial to the financial transaction request and a reply to a consumer 020 based on the approval or denial. In some embodiments, authorization can include compiling logistical information associated with the advertisement and the e-commerce transaction request. Logistical information such as sale, packaging shipping, or delivery information can be tracked and can trigger automated event statuses to be sent via a text message to the consumer 020.

A media outlet 010 can be any type of entity that places content in front of prospective consumers 020 such as television, a computer, signage, printed material, a radio broadcast, a wireless mobile communication device, or even an advocate to name a few. Publishing can be defined as the process of production and dissemination of literature or information printed or electronic including the activity of making information available to the general public through any media outlet. Pull type ad methods can include an advertiser/facilitator 000 (goods and service providers), media outlets 010, a consumer 020, a CID 030, a product type 040, an ad/marketing text campaign application 050, a FECA 070, a payments gateway 080, a TAAE 090, and a fulfillment entity 100 or a product producer/provider to name a few.

In a specific example, the advertiser/facilitator 000 can be a jeweler, media outlet 010 can be a television, the product type 040 can be a good such as a diamond ring, the ad/marketing text campaign application 050 can be e-TXT, the FECA 070 can be Extreme Mobility, the payments gateway 080 can be Visa, the TAAE 090 can be a financial institution 091 such as a bank that is responsible for the issuance. and administration of a credit card account, and the fulfillment entity 100 can be a jewelry importer, manufacturer, warehouse, or distributor.

The ad/marketing text campaign application 050, FECA 070, payments gateway 080, TAAE 090, and fulfillment entity 100 can: each reside on programmable and/or processing devices such as one or more servers; receive data and control signals; store and manipulate data; and provide output in a useful format. The CID 030 and the servers can be in communication with one another over a secure network. The products offered advertiser/facilitator 000 can be advertised via various types of media outlets 010 such as television 011; web-based postings 012; fixed location public displays 013; printed marketing materials 014; publications such as newspapers or magazines 015; radio broadcasts 016; public announcements 017; wireless device-based communications 018; and advocates 019 such as spokespersons and or sales people.

The consumer 020 can be exposed to visual or audible content and can utilize a CID 030 to respond to the content. The CID 030 is a device that allows the consumer 020 to initiate communication with an ad/marketing text campaign application 050 via a text message to a specific telephone number or to a short code to indicate interest in the advertised product. The ad/marketing text campaign application 050 receives the text message from the consumer 020 then transmits a text message with reply path such that a consumer 020, via a CCD 030 can select the reply path to conduct an e-commerce transaction to acquire the product. The CID 030 is capable of allowing the consumer 020 to respond to text content over a secure connection to the FECA 070 transmit an e-commerce transaction request, and receive a response to the e-commerce transaction request from the FECA 070. The CID 030 can then display the response to the consumer 020. The CID 030 could include any device capable of being mobile and/or capable of communicating with another device with or without a wired connection.

In operation, a consumer 020 can be exposed to an advertisement for a number of different types of products 040 including, but not limited to, soft or durable goods 041, services 042, event tickets 043, donations to non-profit organizations, charities, political campaigns, organizations or causes 044, additional value to prepaid cards 045, and payment of bills or invoices 046. The telecommunications network 060 allows the CID 030 to communicate to a wired communication device such as the FECA 070, the telecommunications network 060 can translate textual and other communication protocols into the desired format for secure network communications.

The efficiency of the disclosed embodiments allows for an advertiser to serve an ad to a first-time customer and receive a payment for a product from the first-time customer without a lengthy exchange of information such as a download, local execution of an application from a financial institution such as a payment gateway or a transaction account authorization entity, and tediously entering data. The disclosed configurations provide a fast, ad-hoc, and with “one touch” or “few touches” input from a consumer can put the consumer in touch with his transaction account facilitator. Such a method allows for a smooth and pleasurable consumer experience for a customer who wants to initiate and complete an e-commerce transaction.

A transaction account can be considered a debit, credit, or prepaid account from which a consumer 020 can make debits against and/or transfers finds to third parties. Demand-deposit accounts, negotiable order of withdrawal (NOW) accounts, automatic transfer service (ATS) accounts, credit union share draft accounts, brokerage accounts, insurance accounts, credit card accounts, or prepaid accounts are examples of transaction accounts at banks, other depository institutions, or third parties. Payments gateways 080 are linking entities that have networks that communicate with acquirers of financial transactions and issuers of payment vehicles. These networks facilitate the communication among network participant for the purpose of exchanging financial transactions. Visa, MasterCard, Interac, NYCE, and Star are examples of payment gateways in North America.

The TAAE 090 can grant or deny access to the consumer's transaction account. The TAAE 090 can provide authorization in a two-step process. The first stage can be authentication, which ensures that a consumer 020 is who he or she claims to be and the second stage can be authorization, which allows the consumer 020 access to the transaction account funds based on the consumers 020 identity. The FECA 070 can be responsible for initiating a financial transaction request via payments gateway 080 to the TAAE 090 to request and obtain approval for a financial transaction request. The FECA 070 can also transmit confirmation information such as a sale, packaging shipping and/or delivery information, or a record or receipt of the completed financial transaction to the fulfillment entity 100 to complete the transaction. The FECA 070 can include a database 071 that can store the account information of the consumer 020.

The payments gateway 080 can provide an interface to and can communicate with a TAAE 090 to facilitate finding for or authorization of a financial transaction request. The TAAE 090 could be a financial institution 091 where the consumer 020 has an assigned and approved transaction account such as a credit card account or a bank account, a prepaid service provider 092, or a goods or service provider 093 where the consumer 020 has an assigned and approved financial account such as a credit or prepaid account. It can be appreciated that the account held by TAAE 090 includes any funding or financial account from which the consumer 020 can control. The TAAE 090 could manage consumer's 020 bank accounts, credit card accounts, prepaid accounts, brokerage accounts, insurance accounts, mobile wallet accounts, or any credit or debit account. Payments gateway 080 can communicate with the TAAE 090 over a secure system-dependent network 085. In some embodiments, a financial transaction authorization via a TAAE 090 can be completed in near real-time or with minimal delay such as in the case where the payments gateway is the Automated Clearing House (ACH) and the authorizing TAAE 090 is a financial institution 091 housing the funding or financial account. The disclosed system can pre-verify the consumer's 020 identity as the signatory, owner, or controller of the transaction account based on the consumer's mobile device identifier to seamlessly, easily, and automatically facilitate transaction approval by the system.

One purpose of fulfillment entities 100 is to complete (the loop on) the non-financial aspects of the e-commerce transaction processing such as packaging, shipping, delivery, and receipt verification for the contribution, good, and/or service. The fulfillment entity 100 could be a retailer 101, manufacturer or distributor 102, a creditor 103, a utility company 104, a financial institution 105, a prepaid service provider 106, or a fulfillment house 107. Once the financial transaction has been made and affirmed through the payments gateway 080, the records or database of the fulfillment entity 100 can be updated accordingly. Fulfillment of an e-commerce transaction can vary based on what product or service was acquired, what the specified delivery conditions are, and other parameters as blown by or determined by the fulfillment entities 100 such as delivery tracking via the Internet.

The FECA 070 can communicate with the fulfillment entities 100 over any type of network such as a private communication network, a public network, or a secure system-dependent network 085 in order to initiate fulfillment of the e-commerce transaction request or for providing assistance with the deliverables, it can be appreciated that an advertiser/producer 001, such as a producer of or distributor of a product who advertises and is a facilitator of commerce, typically desires to be able to evaluate the effectiveness of their ad campaign. Heretofore, with media outlets 010 such as radio and television, there was no effective and efficient way to accurately determine how many potential customers 020 who were targeted and actually received an advertisement, and how many people who, as a result of being exposed to the advertisement, actually completed a transaction or took some other action based on exposure to the advertisement.

Likewise, heretofore, it has been difficult if not impossible to accurately measure the effectiveness of customer 020 or client loyalty programs, couponing campaigns, and other promotional efforts. Some embodiments herein provide an automated system for accurately determining audience behavior or reaction to an advertising impression and ultimately providing an effectiveness metric for an ad campaign back to the advertiser so that the advertiser can determine not only the cost per exposure, but also the cost per sale from a particular ad campaign. Thus, different types of ad campaigns (methods, etc.) on a particular product, type of product, and group of products can be rated as to their effectiveness. It can be appreciated that an ad campaign for a particular group of products via timing and particular media outlet may be very successful, while nearly the same campaign parameters when used for a different group of products may fail miserably.

Thus, the disclosed ad campaign effectiveness/measurement module 005 can use effectiveness data to suggest campaign strategies and can assist an advertiser in implementing an ad campaign based on the product to be marketed. In some embodiments, if an advertiser provides parameters regarding a proposed ad campaign, the system can accurately forecast the likely success of the proposed campaign or the cost per exposure or cost per sale for a particular ad campaign and expected returns. The disclosed system can collect data based on consumer feedback from specific advertisements and such data can be stored, analyzed, and utilized for future campaigns. Such data can enable an advertiser to more accurately determine or predict audience behavior or audience reaction based on a proposed advertisement or ad campaign. The data also allows a prospective advertiser to predict targeted audience reactions for a proposed ad campaign prior to the creation and delivery of the ad or marketing message.

For example, the disclosed system might provide data that suggests changing delivery parameters such as the type of media outlet, ad content time of day or a combination thereof to make the, ad campaign more effective. Such suggestions can be made based on past successes metrics or circumstances that can predict better ad campaigning based on past data. In some embodiments, the system can be set up as a pull type ad campaign where an advertiser via the system provides content to a consumer and the consumer via their CID 30 can respond to an ad via a reply path provided by a text based communication system. Such a connection allows the consumer to conduct an e-commerce transaction and possibly acquire the product. The disclosed system can operate in a push or pull format.

Thus, for a propose ad campaign, the disclosed system can provide an accurate estimate for a business's ad return on investment (ROI) to better assist an advertiser in planning an ad campaign. The disclosed system can also provide suggestions or proposals to an advertiser based on an advertiser's needs or based on a proposed ad campaign from an advertiser. For example, based on the desired target audience or the products to be advertised and sold, the disclosed system might suggest the best media outlet and ad timing for a particular ad campaign. Such suggestions can be based on historical data such as the success of previous ad campaign with similar material factors. The disclosed system can provide a cost benefit or a projected effectiveness or ROI rating for a proposed ad campaign to the advertiser prior to launch of the campaign and the advertiser can use this prediction model to make changes before a final launch decision. Thus, the disclosed system can utilize and analyze the ad campaign parameters and compare them to campaign parameters from past campaigns and provide the prospective advertiser with projected success metrics such as audience penetration for various consumer 020 classifications. The system can provide estimated metrics and suggestions to a prospective advertiser regarding how to maximize the return on their ad dollar.

Continuing with FIG. 1, an advertiser producer 001, a production facilitator 002, an ad agency/corporate marketing department 003, a data clearinghouse 004, and an ad campaign effectiveness/measurement module 005 can interact to provide feedback regarding the ad campaign before the ad campaign is started thereby providing increased sales or fund raising. Advertisers often want to target a cross-section of the public to improve ad effectiveness and thus, get the most return from their ad expenditure. There are different levels of targeting customers or au audience. For example, an advertiser/producer 001 can choose to target potential customers based on geographic, demographic, and behavior characteristics to name a few. Depending on the product, geographic targeting is a coarse targeting method, however, behavioral targeting provides much finer granularity for targeting advertising.

It can be appreciated that often the finer the granularity, the more expensive the cost of the ad per exposure. Behavioral targeting can be performed when the advertiser not only knows something about the audience's geographic and demographic characteristics, but also about the audience's behavioral characteristics. Thus, targeted ads can be sent to an individual consumer 020 based on geographic, demographic, and behavioral data. For example, an ad for a new Ferrari dealership in Omaha, Nebr. can be sent to a wealthy executive in the Omaha area who drives a newer Porsche. For micro targeting, audience data can be purchased from an agency or can be obtained and can be data related to the monitoring of user movement acquired by the CID 030. The disclosed system and method can also provide customer data to third parties.

Initially, an advertiser/producer 001 can create the ad campaign, which will typically include a budget and target audience. The producer will often consult an ad agency/corporate marketing department 003 for advice regarding a campaign plan to determine how to maximize exposure to desirable audience targets for a given budget The advertiser/producer 001 or the ad agency/corporate marketing department 003 could hire or consult with a production facilitator 002 (often part of the media outlets 010) to produce and publish the advertisement After an advertisement is published or inn, an advertiser/producer 001 can get data regarding how, when, and if the ad ran and what audience was exposed to the advertisement. This data can be compared to the original ad campaign plan to see if the advertiser/producer's 001 ad(s) got the exposure that they paid for or they desired. Adjustments to the cost and/or the mechanics of the campaign can then be made according to actual exposure results/data instead of projected results. In some embodiments, a data clearinghouse 004 can monitor multiple audience interactions with electronic CID 030 and, for example, can acquire audience data such as behavioral data based when a consumer 020 such as an audience member performs a transaction on an electronic CID 030 based on exposure to an ad provided by media outlets 010. Systems such as the FECA 070 and/or the fulfillment entities 100 can also provide consumer 020 activity or e-commerce transaction data to the data clearinghouse 004.

Although data clearinghouse 004 and other parts of the system are shown as if they are, placed at a single location, in some embodiments, data clearinghouse 004 and other system components can be ubiquitous and can have and operate in many locations simultaneously where there is data to be acquired and mined. The ad campaign effectiveness/measurement module 005 can accept data such as which ads ran, if the ads ran as scheduled, when they ran, how much exposure the ad received, how much money was spent, per target, what media or combination of media was used, how many consumer 020 reactions the ad created, how many purchases inquires, responses the ad created, what percentage of the audience exhibited what particular responses, etc. Thus, the ad campaign effectiveness/measurement module 005 can set metrics by which future campaigns can be compared or measured. In some embodiments, the system allows a media outlet 010 to charge a premium price per ad because of the data that can be provided that shows a success rate of the advertisement. In some embodiments, the service providers can set up a pay for performance system where the advertiser/producer 001 only pays for ads that result in a purchase or some type of transaction.

In accordance with another important aspect of the present invention, after an e-commerce transaction is completed based on an ad/marketing campaign, the advertiser/facilitator 000 can communicate with the consumer 020 using this system. This communication can include any information related to the e-commerce transaction (i.e., order confirmation, sales receipt, shipping info, addressing info, delivery method, projected delivery date, return info, etc.). Any or all of the functions of the advertiser/facilitator 000, the ad/marketing text campaign application 050, the FECA 070, the payments gateway 080, the TAAE 090, and fulfillment entity 100 may reside on one or more specialized servers.

In some embodiments, the system can be utilized as a fan appreciation and awards system using a fan card to facilitate the system. In these embodiments, sports organizations can issue gift loyalty cards to the fans. As the fans use their cards, they earn loyalty points with the organization. The organization can push out MS ad messages with reply paths to have fans “top-up” their fan cards or purchase franchise items via the disclosed system. The organizations can also push out incentives for sponsor related products. In some embodiments, a credit/debit card system can be incorporated such as Visa, MasterCard, American Express or a gift/loyalty card provider such as Opticard for authorization and tracking financial transactions. This allows a fan or loyalty member to use the same card at games and events via concession stands, kiosks, merchandise stores, etc., to cut down on cash transactions and employee theft.

Media outlets 010 could be a television 011 where ad or marketing messages can be displayed or articulated on the television 011 using different types of formats including, but not, limited to, commercials, paid promotional programming, and shopping based channels or networks. In some embodiments, media outlets 010 could be embodied by a web-based content 012. Web-based ad or marketing messages may be displayed or articulated on a variety of sources including, but not limited to, web ads, websites, and social network postings, and could use selectable links. Web-based content may be viewed or heard on a number of different devices including, but not limited to, personal computers, laptops, net books, PDAs, and smart phones.

Media outlets 010 could also be embodied as a static or dynamic public display 013. Ad or marketing messages could be displayed or articulated on a variety of viewable sources including, but not limited to, static or dynamic billboards, scoreboards, movie trailers, displays or posters. In some embodiments, media outlets 010 could consist of printed marketing material 014. Ad or marketing messages may be read from a variety of marketing material sources including, but not limited to, direct mail, postcards, letters, brochures, pamphlets, and flyers.

Media outlets 010 could also consist of publications such as newspapers or magazines 015. Ad or marketing messages may be read from a variety of periodical sources including, but not limited to, newspapers, magazines, newsletters, and circulars. In some embodiments, media outlets 010 could consist of a radio station 016. Ad or marketing messages may be articulated on a radio during a variety of broadcasts including, but not limited to, commercials and paid promotional programming.

Media outlets 010 could further consist of a public announcement 017. Ad or marketing messages may be articulated during a public broadcast at various events including, but not limited to, spoiling, entertainment, political, promotional, fundraising, and charitable events. In yet additional embodiments, media outlets 010 could consist of a wireless device-based communication 018 where ads could be displayed or articulated using a variety of sources and formats including, but not limited to, text messages, micro-blogging messages, web ads. websites, and social network postings. Wireless devices 018 could include, but not limited to, devices such as laptops, notebooks, tablet computers, PDAs, and smartphones. Media outlets 010 could also consist of an advocate, salesman, speaker, representative or spokespersons 019 where the person representing the product or fundraiser can articulate the message.

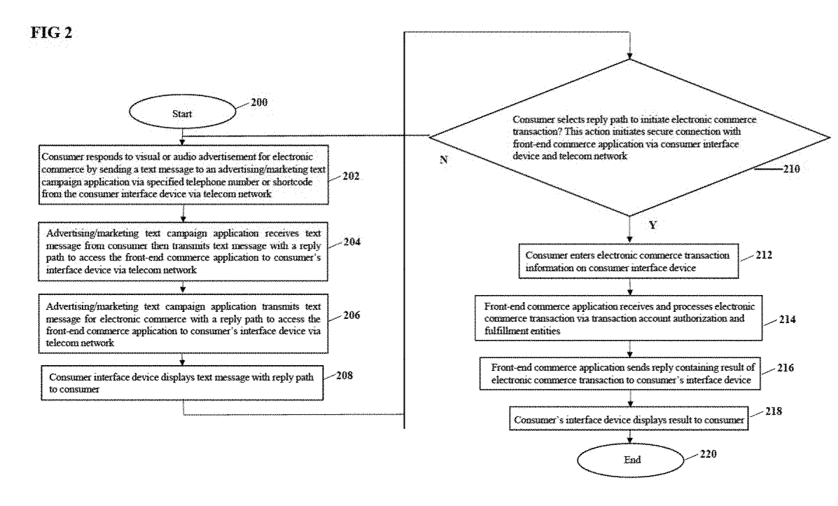

Referring to FIG. 2, a flow diagram is provided depicting a pull type advertising-marketing message monetization process. The process begins at block 200 and proceeds to block 202 where the consumer after being exposed to an advertisement content can respond to the advertising impression by sending a reply to the impression via a messaging service. The. consumer response can take many forms such as a reply to a specified address or phone number, selection of a displayed link, or the entering and transmission of a short code from a consumer's CID. As illustrated by block 804, the ad/marketing text campaign server can receive the transmission from the consumer's CID and in response, per block 206, can transmit a reply message via a messaging service to create a secure reply path between FECA and the consumer's CID via a telecommunications network. As illustrated by block 208, CID can display the reply message via the CID.

In some embodiments, the message sent by the FECA can include an embedded hyperlink that, when activated or selected by a consumer can seamlessly activate a browser on CID and retrieve an interface page and display the page thereby “taking” the consumer to a predetermined website possibly by utilizing a universal resource locator (URL). Thus, the disclosed system can have a link or reference within or associated with what is the displayed to the consumer, that when selected on the CID will automatically redirect the consumer via. CID to a browser based GUI where a financial transaction can be performed. As illustrated by decision block 210, if a consumer replies to the provider's offer, a secure connection will be initiated between the system and the CID. However, if the consumer does not select the link, the process can proceed to block 202 and the process can start over again. With one or more touches of the CID screen or a keypad, a consumer can be directly linked to a website where a transaction such as a donation, a purchase, or an agreement to purchase can be completed. Thus, a consumer request to perform a transaction made in response to a messaging system based advertisement can seamlessly redirect the consumer to FECA where a secure transaction can be completed.

As stated above, upon a consumers textual input or selection of a link provided, as illustrated, in decision block 210, the consumer's CID can be seamlessly connected over a secure connection with FECA CID via a telecommunications network. As illustrated by block 212, the consumer can be prompted for and, enter data to finalize the transaction such as entering the number of items to be purchased, delivery option, delivery address, and various item attributes such as color, size, or date of event/delivery. The consumer can also be prompted for and enter payment information to identify and access a funding or financial account on CID. It can be appreciated that payment information to identify, access, and modify or debit a funding or financial account may include, but is not limited to, a user ID, a pass code, a card number, a security code, card verification code, a bank routing number, an account number, an identification name, a password, an access code, a PIN, security questions, or any combination thereof.

The FECA can identify that the response received from consumer is based on a particular advertisement which was sent to the same phone number associated with the consumer's replies. As illustrated by block 214, FECA payment gateway and/or TAAE can authenticate that the MS message is a response from a known advertisement and originated from a known phone number and that the phone owner is authorized to make such a transaction via records such as bank records. In some embodiments, the TAAE can check and see what telephone number or consumer device identifier that the consumer has on file with their financial account, or an identification number that the consumer has conducted transactions with in the past and possibly collaborate financial data or subscriber data bills payment records, etc., of a carrier such as AT&T, T-Mobile, etc. As illustrated by block 216, based on these and other verification/authentication methods/data, the TAAE can authorize the financial transaction and transfer funds or points amongst accounts and send records of such transactions to other components such as fulfillment entity and the advertiser/producer so they can take action or calculate a commission, if applicable.

In some embodiments, if the consumer has previously utilized FECA, payment information may already be stored based on unique wireless communication device identifier and the consumer may not be required to be entered data for each sequent financial transaction. The consumer however may be required to enter a secret code such as PIN, password, CVV/CVC, etc,, to verify access to the funding or financial account. If the consumer has never before utilized the FECA or desires to use a different funding or financial account than the account on file, then the system can ask the consumer to enter new or different account or payment information. The system can implement a process method that allows multiple funding or financial accounts to be stored for each consumer for use, for subsequent transactions by the consumer. As illustrated by block 218 to close the communication loop, the system can verify that the consumer who requested the transaction was the consumer who the ad was actually sent to, to avoid a situation where a loyal consumer is provided with a reduced or preferential price and this customer forwards the ad to others who when trying to purchase at the preferential price would be denied such a benefit. The provider can configure the system to avoid this phenomenon and can implement other anti-theft measures.

Summarizing FICA can receive the e-commerce transaction request from the CID and in response, the FECA 070 can process the commerce transaction request by coordinating with TAAE and a fulfillment entity. The FECA can send a reply directly to the CID that contains a result of an e-commerce transaction and the CID, as illustrated by block 218, can display the results to the consumer. In the event that the financial or fulfillment portions of the request are not approved, the FECA can reject the e-commerce transaction and the appropriate message for display by the CID, to inform or alert the consumer of a successful transaction or a failed transaction.

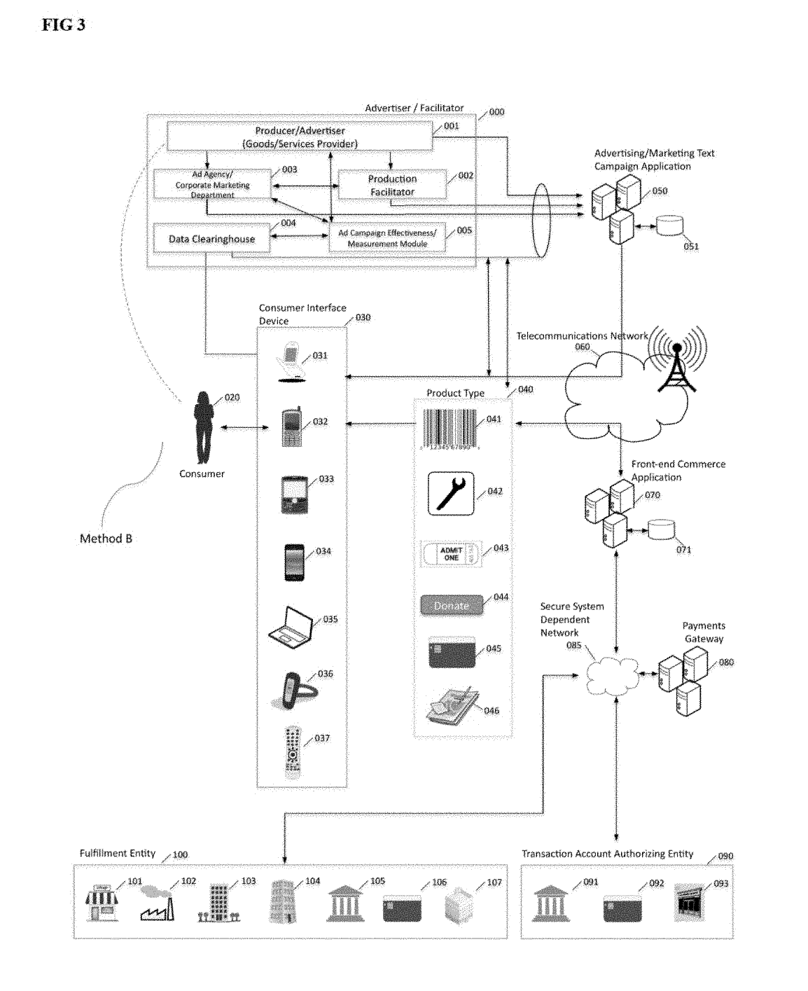

Another method embodies a push type ad/marketing campaign wherein consumers respond to text based advertisements sent to their CID related to an e-commerce transaction such as a donation or purchase of a product. FIG. 3 is a block diagram illustrating modules and their inter-relationship for a push type ad/marketing campaign. With reference to FIG. 3, a text based push type ad/marketing embodiment is disclosed in accordance with the present disclosure which can include an advertiser/facilitator 000, an ad/marketing text campaign application 050, a consumer 020, a CID 030, a FECA, 070, a payments gateway 080, a TAAE 090, and a fulfillment entity 100. The advertiser/producer 001 could be a football franchise, the TAAE 090 could be a prepaid card provider 092 responsible for issuance and administration of a prepaid fan card account, and the product provider/fulfillment entity 100 could be a sporting event ticket broker. The ad/marketing text campaign application 050, FECA 070, a payments gateway 080, TAAE 090, and fulfillment entity 100 can each reside on devices capable of processing information and can be programmable devices such as servers that receive input, store, and manipulate data, and provide output in a useful format. The CID 030 and such servers can be in communication with one another.

One purpose of the ad/marketing text, campaign application 050 is to generate at least one ad/marketing text message with an embedded reply path or hyperlink to facilitate a seamless e-commerce transaction based on the message to generate a distribution list including at least one consumer 020 and to initiate transmission of at least one text message. Text to buy services such as e-TXT is typically subscriber-based services where the subscriber provides a campaign distribution list and a marketing or ad message to be transmitted to the recipients. A database 051 can store the subscriber and campaign information.

The CID 030 communicates with the ad/marketing text campaign application 050 via a telecommunications network 060. The telecommunications network 060 is a collection of terminals (starting and stopping points in any telecommunication network environment), links, and nodes that connect together to enable telecommunication between users of the terminals. Examples of a telecommunication network include computer networks, the Internet, the telephone network, cellular networks, the global Telex network, and the aeronautical ACARS network,

An embedded hyperlink can be sent to and the consumer 020 can receive the text messages and can click on the embedded hyperlink to initiate an e-commerce transaction request utilizing a CID 030. Thus, the CID 030 can be a device that allows the consumer 020 to initiate e-commerce transaction requests. The CID 030 is capable of allowing the consumer 020 to respond to the ad/marketing message, set up the connection to the FECA 070, transmit the e-commerce transaction request, receive the e-commerce transaction request response from the FECA 070, and display the response to the consumer 020. Examples of CID 030 include a mobile cellular phone 031; a wireless enabled personal digital assistant (PDA) 032; a mobile cellular capable personal digital assistant such as a smartphone 033; a portable media player with a mobile communication platform 034; desktops, laptops, netbooks, and tablets 035; wireless headsets such as Bluetooth devices 036; and television remote control devices 037. The telecommunications network 060 allows the CID 030 to communicate to a wired communication device such as the FECA 070, the telecommunications network 060 can translate textual and other communication protocols into the desired format for secure network communications.

FECA 070 can be responsible for initiating a financial transaction request via payments gateway 080 to the TAAE 090 to request and obtain approval for a financial transaction request. The FECA 070 can also transmit continuation information such as a sale, packaging shipping and/or delivery information, or a record or receipt of the completed financial transaction to the fulfillment entity 100 to complete the transaction. The FECA 070 can include a database 071 that can store the account information of the consumer 020.

The payments gateway 080 can provide an interface to and can communicate with a TAAE 090 to facilitate funding for or authorization of a financial transaction request. The TAAE 090 could be a financial institution 091 where the consumer 020 has an assigned and approved transaction account such as a credit card account or a bank account, a prepaid service provider 092, or a goods or service provider 093 where the consumer 020 has an assigned and approved financial account such as a credit or prepaid account. It can be appreciated that the account held by TAAE 090 includes any funding or financial account from which the consumer 020 can control. The TAAE 090 could manage a consumer's bank account, credit card account, prepaid account, brokerage account, insurance account, mobile wallet account, or any credit or debit account. Payments gateway 080 can communicate with the TAAE 090 over a secure system-dependent network 085. In some embodiments, a financial transaction authorization via a TAAE 090 can be completed in near real-time or with minimal delay such as in the case where the payments gateway is the Automated Clearing House (ACH) and the TAAE 090 is a financial institution 091 housing the finding or financial account. The disclosed system can pre-verify the consumer's 020 identity as the signatory, owner, or controller of the transaction account based on the consumer's mobile device identifier to seamlessly, easily, and automatically facilitate transaction approved by the system.

One purpose of fulfillment entities 100 is to complete (the loop on) the non-financial aspects of the e-commerce transaction processing such as packaging, shipping, delivery, and receipt verification for the contribution, good, and/or service. The fulfillment entity 100 could be a retailer 101. manufacturer or distributor 102, a creditor 103, a utility company 104, a financial institution 105, a prepaid service provider 106, or a fulfillment house 107. Once the financial transaction has been made and affirmed through the payments gateway 080, the records or database of the fulfillment entity 100 can be updated accordingly. Fulfillment of an e-commerce transaction can vary based on what product or service was acquired, what the specified delivery conditions are, and other parameters as known by or determined by the fulfillment entities 100 such as delivery tracking via the Internet.

It can be appreciated that a retailer/advertiser/provider 101 desires to be able to evaluate the effectiveness of their ad campaign. Heretofore, with media outlets 110 such as radio and television, there was no way to accurately determine how many people who were targeted and actually received an advertisement, and how many people who as a result of the ad made an e-commerce transaction or took some other action based on exposure to the advertisement. Likewise, heretofore, it has been difficult if not impossible to accurately measure the effectiveness of loyalty programs, couponing campaigns, and other promotional efforts. Some embodiments of the present disclosure provide an automated system for accurately determining audience behavior or reaction and ultimately providing effectiveness metric back to the advertiser and providing suggestions to the advertiser on how to maximize the return on their ad dollar.

Continuing, FIG. 3 includes an advertiser/producer 001, a production facilitator 002, an ad agency/corporate marketing department 003, a data clearinghouse 004, and an ad campaign effectiveness/measurement module 005. Advertisers often want to target a particular group to achieve a better effectiveness and thus get the most revenue out of their ad expenditure. There are different levels of targeting customers or an audience. For example, an advertiser/producer 001 can choose to target potential customers based on geographic, demographic, and behavior characteristics to name a few, where geographic is a fairly course targeting method and behavioral targeting provides a much finer granularity of targeting. It can be appreciated that often the liner the granularity, the more expensive the cost of the ad per exposure. Behavioral targeting can be performed when the advertiser knows something about the behavior of a potential customer. Such data can be the e-commerce transaction or the consumer's 020 activities related to the advertiser's campaign.

Initially, an advertiser/producer 001 will define the ad campaign, which typically includes budget and target audience, and, will often consult an ad agency/corporate marketing department 003 for advice, plan, or campaign to determine how to maximize exposure to targets for a given budget. The advertiser/producer 001 or the ad, agency/corporate marketing department 003 will then often hire or consult with a production facilitator 002 (often part of the media outlets 010) to produce the advertisement. After an advertisement is displayed, run, etc., an advertiser/producer 001 wants to get data regarding when and if the advertisement ran and what audience was exposed to the advertisement. Then, this can be compared to the plan to see if the advertiser/producer 001 got the exposure that they paid for.

Adjustments to the cost of the campaign can then be made according to actual exposure results instead of projected results. In some embodiments, a data clearinghouse 004 can monitor multiple communication lines and, for example, can acquire behavioral data based When a consumer 020 such as an audience member performs a transaction based on exposure to an ad from a media outlet 010. Systems such as the FECA 070 and/or the fulfillment entities 100 can also feed transaction data to the data clearinghouse 004.

Although a data clearinghouse 004 is shown at a single location, in some embodiments a data clearinghouse 004 can be ubiquitous and can have and operate in many locations simultaneously where there is data to be mined. The ad campaign effectiveness/measurement module 005 can accept data such as if ads ran as scheduled, or when they ran, how much money was spent on the campaign, or per target, what media or combination of media was used, how many actions, e-commerce transactions, inquires, etc., occurred, what percentage of the audience exhibited what particular responses, etc. Thus, the ad campaign effectiveness/measurement module 005 can set a metric by which all future campaigns can be measured. In some embodiments, the system allows a media outlet 010 to charge a premium price per ad because of the success rate of the advertisement. In some embodiments, any of the services providers in the system can set up a pay for performance system where the advertiser/producer 001 only pays for ads that result in an e-commerce transaction.

In accordance with another important aspect of the present invention, after an e-commerce transaction based on an ad/marketing campaign, the advertises/facilitator 000 can communicate with the consumer 020 using this system. This communication can include any information related to the e-commerce transaction, (i.e., order confirmation, sales receipt, shipping info, addressing info, delivery method, projected delivery date, return info, etc.).

Any or all of the functions of the advertiser/facilitator 000, the ad/marketing text campaign application 050, the FECA 070. the payments gateway 080, the TAAE 090, and fulfillment entity 100 may reside an specialized servers. Logistics is the management of the flow of goods between the point of origin and the point of use in order to meet the requirements of customers or corporations. The fulfillment entity can provide logistics including the integration of information, transportation, inventory, warehousing, material handling and packaging, and security therefore. The fulfillment entity need not be the same entity as the facilitator or producer/provider of the goods or services and can provide a channel of the supply chain that adds the value of time and place utility and can deliver anything from military, commercial, and consumer goods and services.

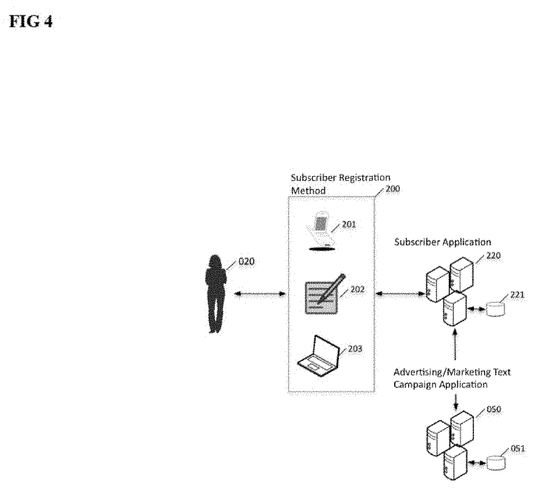

With reference to FIG. 4, subscriber opt-in/registration to a push ad/marketing text campaign is disclosed which discloses a consumer registration method 200. The disclosed method can facilitate interactions between a consumer 020, a subscriber application 220, a database that stores subscriber data 221, and an ad/marketing text campaign application 050. It can be appreciated that the disclosed example reflects a consumer 020, who is a member of a fan club, and registers with the fan club via a subscriber application 220 to receive information and advertisements from the club. The subscriber application 220 and the ad/marketing text campaign application 050 can each reside on programmable devices, such as specialized servers, which can receive input, store and manipulate data, and provide output in a useful format.

Through this method, a consumer 020 may opt-in or register with a subscription application 220 by utilizing a number of different subscriber registration methods 200 via use of a messaging system or an IP based browser via CID or a smartphone 201. Thus, a fan can fill out a registration form or application form 202, which can be a web-based registration form via connecting to a website 203. Filling out a form may be facilitated by asking a series of questions to the prospective fan club member and/or could utilize additional processes to acquire information to complete a subscription's application 220.

The subscription application 220 can allow a group of consumers 020 to provide their in such as name, telephone number, postal address, email address, and contact preferences which can then be utilized in targeted marketing campaigns. Example of groups of consumers 020 may include fans or enthusiasts, loyalty program participants, customer bases, and donor bases. The subscriber application is responsible for generating ad/marketing campaign distribution lists for the ad/marketing text campaign, application 050. In some embodiments all or part of the data storage and functions of the subscription application 220, the ad/marketing text campaign application 050, and/or any of the functions of the advertiser/facilitator 000 may reside on a specialized server. The disclosed system can optimize which consumers 020 receive which ads and requests for replies. Such optimization can be achieved by building profiles of consumer 020 using consumer 020 geographic, demographic, and consumer 020 behavioral information that can be linked to each phone number in the disclosed system. This information can be acquired in near real time from third parties and can be supplemented with the information the disclosed system has acquired.

To determine the consumer's 020 location, the disclosed system can use information provided by the phone or device for MS messages. Such location information can also be acquired from information supplied by the carriers and can work on phones that don't have a global positioning system (GPS). In some embodiments, a consumer 020 can receive a location-based ad promoting a local merchant. This ad could come, for example, at the bottom of a MS message sent by an advertiser. This MS ad could then link to a wireless application protocol (WAP) page that features the provider's address, phone number, and other information. The disclosed system could bill for both the initial ad unit (on a cost per click (CPC) basis) and from a secondary action when the consumer 020 reacts to the WAP site.

In some embodiments, consumers 020 can specify if they'd like to receive MS based offers from local or national providers and can specify certain categories that they are interested in receiving information about. The ads can be integrated with MS content that a consumer 020 has agreed to, for example, a news feed. In some embodiments, an ad/marketing text campaign application 050 can append contextual ads to user generated text messages. Such appending can be performed based on targeting and profiling as well as the context of the message or multiple messages (i.e., the conversation). Advertisers can pay for each MS sent. In some embodiments, mobile operators can make additional revenue When generating a response from the receiver of the ad either based on a call back number or when there is a clicking on the URL based on data charges, etc. MS advertisements can convey an emotion, a greeting, a romantic phrase, etc., and understanding this “emotion” is part of serving an ad that will promote a positive response.

It can be appreciated that the disclosed system does not require that a consumer 020 be known or identified and have au established user id on file within au information management system as requirement by prior systems. Prior systems allow for tenting a link for a website where the communication requires a user name and password for the consumer 020 to navigate through an ordering process. Existing MS financial transaction type systems operate in a closed environment where the user of the information management system that is the equivalent to the FECA 070 is required to be known by the CID 030. Thus, existing MS based financial transaction systems require an established relationship between the device and a payment system where the disclosed system can accommodate a first-time client without requiring registration IDs, etc. The disclosed system provides an open environment, transaction system where the consumer 020 is not required to be known or have an established interface with the FECA 070.

These operations of the closed text to financial transaction systems are substantially identical to the process required to order a good via a website from a personal computer because of the way the FECA 070 and the payment gateway 080 operates. The disclosed system allows a consumer 020 an immediate gateway to buy a product in the moment even when advertisements are broadcast over traditional media outlets such as television and radio. The disclosed embodiments can transmit a very specific invitation to buy based on an advertisement that is sent to a consumer 020. Based on the specific invitation, the system can collect consumer 020 data using an analytics engine that can provide to the retailer's competitive location based information, consumer 020 behavior data based on ad, and location based product demand. An analytics engine can operate on data that is captured from responses to invitations to buy including the exposures resulting in financial transactions, etc.

Some providers provide a bug on their website that opens the mobile payment gateway where you have to be a registered customer to access the system that is shown on the website. These systems provide for the financial transaction through in-app ad on websites or smartphones. The disclosed system does not require an application on the phone and in addition, the disclosed system monetizes ad via a MS transaction. The disclosed system has the unique ability to monetize a response to an ad in the moment, in real time or in near real time using any consumer 020 device that supports a MS system. Systems that require a consumer 020 to register from a personal computer prior to texting to financial transaction have many drawbacks. For one, they are incapable of the monetization of traditional ad. The disclosed system operates without the consumer 020 having to go to a website and establish an account using their computer. The integration with the front-end commerce application into the system provides unique results by providing the capability of providing instant monetization of text messages.

It can be appreciated that information regarding purchasing and delivery of goods and services can include significant confidential data. In some embodiments, CID 030 can send and receive messages using a secure communication or encrypted MS message. Such security can be performed by the CID 030 inside or outside of the subscriber identity module (SIM) card. Thus, the encryption may or may not be linked to the SIM. When a consumer 020 receives an incoming MS message with an ad, a verification check can be made to check if the message contains configuration instructions or software to be installed. If not, the MS can be processed nor really as a conventional MS message. If the message has an ad with configuration commands, the CID 030 can evoke encryption checking by looking up user data and if no data can be located, the MS can be rejected.

For the secure communications, an indicator can be stored in a User Data Header (UDH) and the header can be checked by the gateway to see if the CID 030 can set up some form of secure communications. If no element is detected, the MS can be rejected because the MS does not conform to the security requirement of having encryption. If an element is found, decryption of the message can be performed using a key stored in a memory of the CID 030. The decryption algorithm described is not detailed as any such known procedures may be applied as far as International Mobile Equipment Identity (IMEI) keys, etc. The decryption result can be parsed to extract the bytes, which can be compared to an IMEI personal number also stored in the memory of mobile medium. A mismatch leads to the MS being rejected While a match allows the MS to be processed.

To summarize, a security mechanism for configuring MS messages can be, achieved through an encryption based on a confidential key. The key can be the IMEI number. The activation of the encryption security requires both parties to agree on its use. The managing party needs to encrypt the message and activate the “Encryption Using IMEI” field in the User Data Header of the MS while the user needs to be using a device that is enabled to decrypt a message using the IMEI as the key.

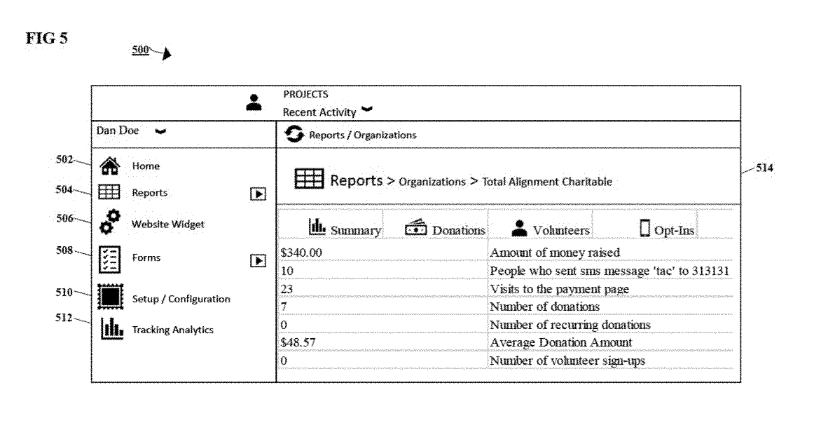

The network node can include a MS message encryption detector to detect whether the received MS message is encrypted and can include a message encrypted/decrypted for selectively encrypting and decrypting MS messages prior to forwarding them to the intended recipient. MS messages that are received unencrypted can be encrypted by the MS message encrypted/decrypted if the intended recipient requires encryption and encrypted MS messages can be decrypted by the MS message encrypted/decrypted if the intended recipient does not support MS message encryption. In some embodiments, the sender of a MS message may have the option of requiring encryption and MS messages received in the network node may, if the intended recipient does not support encryption, forward the MS message to a MS message holding database. When that occurs, the intended recipient is preferably notified and provided with instructions on how to receive the MS message in an alternate manner or using a device that does support encryption. FIG. 5 is a depiction of a web page based graphical user interface that can be utilized by a provider to set up and configure a campaign that can be utilized to solicit consumers and accept payments from consumers.

Referring to FIG. 5, a graphical use interface is depicted 500 that can be utilized by an administrator to set up, configure, and tailor operation, monitoring, and reporting of the disclosed system. The disclosed GUI 500 can be utilized to set up and tailor or customize the look and feel of the system as to content and system operation. The home icon 502 will take the administrator to the home page of the application. In the embodiment shown, the administrator has selected the “Reports” option via the Reports icon 504 as shown by the text in the header section 514 on the right side of the GUI, above the main window which is displaying a provider customized report. The report displayed is a recent activity report showing how much money the campaign has raised, the number of people who have responded, the number of visits to the providers webpage, the number of donations, the number of reoccurring donations, the average donation amount, and the number of people who have signed up to volunteer for the campaign. It can be appreciated that what is placed on this report is customizable by an administrator as the administrator can tailor what is displayed based on the type of campaign and what data the provider deems as relevant by selecting the Reports icon 504 and configuring what the administrator desires to be displayed.

After a provider has been approved and given permission and access to set up a campaign, an administrator for the provider can perform an initial set up by selecting set-up config tab 510 where thereafter the system will send a number of queries to the administrator. For example, the administrator can be asked for contact information, a basic description of their campaign, tax information such as tax status and tax ID, payment processor, the financial institution which to credit funds, etc. Next, the administrator can select the forms/templates tab 508 and can locate forms and/or templates that best suits the needs and business model of the campaign. The administrator can also select the website widget tab 506 which allows the administrator to configure the short code/keyword link that will be sent to prospective consumers. The widget tab also allows the administrator to add, upload, and/or select content to be associated with the campaign and the link. Content can be videos, pictures, forms, music, or any multi-media allowable via website development software. When setting up a campaign, the administrator can review a plurality of selectable forms/templates and content from a library and can chose which forms, templates, and content to use to provide a “best fit” the particular campaign and/or business model of the provider. The forms in the library are “re-useable” in that each provider can select from a package of options and display properties or GUI's. Each form and/or template can have a set of associated business rules and complex yet robust payment flows to fit the needs of different providers. Although the properties and operations of the transactions are generally based on the template and its associated rules, such operations can be overidden by other entities such as credit card transaction processor or independent sales organizations (ISOs) and/or other organizational levels to allow for flexibility. Application programming Interfaces (APIs) can be utilized to return the business model or flow properties responsive to a HTML/JavaScript.

Based on the system set up in response to a consumer selecting the link defined by the administrator (or a shortened URL link), the consumer will send a reply message back to the system which can utilize the administrator configured templates to look up or determine the provider associated with the link, the providers campaign associated with the URL or shortened URL and invoke system operation. Such an interrelationship can be achieved using a look up table, a mapping function, or a math function based on the administrator's set up or template. In addition to determining which provider campaign is associated with the abbreviated URL, the, system can determine what data template is to be utilized to facilitate the transaction and what content to display, what customizations to overlay on to the template, what authorizations and validations should be utilized, and What business rules the system and method will apply when processing the reply link to effectuate a transaction.

The template selected based on the received abbreviated URL can dictate many different background processing operations such as what federal and/or state regulations will apply to the transaction. Thus, at a high level, the template that is associated with the abbreviated URL and utilized to process a transaction will dictate how each particular transaction is processed. Although each transaction can be configured and controlled at the template level, details of the transaction processing can be overridden at the organization level in later stages of the process. Each template can have a layout with specific data fields that require data entries to complete the transaction. The data fields can be filled using dynamic code routines with built-in modules that provide having highly specialized functions to populate data fields in templates. Date fields can include amount of purchase/donation, event details, gateway providers, merchant services providers, etc. In some embodiments, templates can be adopted to accept applications for jobs or volunteer work or simply allow for volunteers to sign up to perform various tasks.

In some embodiments, the system can read data from a preference file and fill a template from which an API can construct an html file and JavaScripts which can be transmitted to the CID for viewing by the consumer. The disclosed system and method easily accommodates displaying different content and different webpage designs and configurations. via the selection of new toolkits that can be added on the back end of the GUI 1500. An administrator utilizing GUI can select the URL abbreviation mode for a particular provider and associate it with a provider campaign/offering and a specific business model template. The administrator can also select a preferred toolkit that is best suited for a particular campaign, for example, Twitter Bootstrap and JQuery Mobile (1.3 & 1.4) are commonly utilized toolkits. Webpages are assembled from the selected template. Widgets available via the Widget tab 506 can be associated with and part of various templates, however, not all widgets may be. compatible with all templates, business rules, and/or frameworks.

Toolkits generally provide the ability for themes or customizations to the look and feel, colors schemes, fonts, etc., of the page or pages that are transmitted and displayed on a consumer's CID. In accordance with some embodiments, the disclosed system and method supports inclusion of custom themes for each individual campaign so that providers can customize the look and feel of their campaign to provide consistent branding and marketing efforts. An administrator can create themes using particular graphic designs, and such designs can be purchased from online theme markets, or such designs can be freely created using application and tools such as those provided as part of the Themeroller web app.

In some embodiments, the system allows for a responsive design, where the page displayed on the CID takes into account that the interaction patterns provided for by the CID such as a smartphone, which has different operational characteristics than a tablet, notebook, or desktop computer. Therefore, the responsive design characteristics of the disclosed system can provide step-up/step-down pattern selections depending on which device is being utilized to conduct the transaction. Thus, the system can conduct cascading style sheets (CSS) based on a CSS media queries and based on the type of CID the system can provide altered screen ratios based on the size of the CID display. In addition, the disclosed system can transmit higher resolution images when a CID with a larger display is detected particularly when more space is allocated to a header of the content. The header can have a default setting, but also can include dynamic code setting such that larger screen paradigms can be sent to the CID, such as parallax scrolling, “menu-ing”, etc.

Some embodiments allow for transmission of and inclusion of content from YouTube and Vimeo based video files on the CID's display. In such embodiments, the video files can be automatically scaled to the correct dimensions for the target CID's display screen. Other video protocols and providers could be utilized if configured during a set up procedure. Streaming video on the CID display can be selected and configured by an administrator via a Video Information GUI. The Video Information GUI can be presented as a proprietary content management subsystem within the system. The GUI associated with the Video Information subsystem can allow the administrator to slide items in the display page template using a designated side and can also allow the administrator to select and incorporate various types of interactive widgets to educate and engage the consumer via a CID. For example, social interaction, full content page, dialogs, external links, videos, audio, and other content can be combined on the display to allow a provider to make their content and campaign richly interactive. The Video Information GUI allows an administrator to easily create, edit, updated, and/or delete content, functions, and/or features as desired from time-to-time and such changes can be operational nearly instantaneously.

A content module can store various content files and can be utilized to manage, design, and deliver content to CIDs for a particular campaign. Such a module allows for the delivery of selectable content in various ways to provide deeper content when needed for various campaign types and models. For example, content module can supply a splash screen on a CID to grab the consumer's attention or can provide detailed policy positions and/or slides that display a succession or set of linked pages that can be utilized by the system to accurately and colorfully express ideas, concepts, impressions, and/or positions. An administrator's selection of the tracking analytics 512 allow an administrator to set up and configure multiple third-party analytics and marketing tools such as Google Analytics, Google AdWords Conversion Tracking, Facebook Remarketing and Facebook Conversion Tracking. Such third-party marketing tools allow providers to analyze and expand their advertising campaigns and track results of various campaigns. If third party marketing tools are incorporated, codes can be specified in the system configuration portal, and the corresponding user interface (UT) components (HTML and JavaScript) would then be included during web view assembly of the page. Other or additional re-marketing and conversion tracking toolsets can easily be integrated with the disclosed system, but operative nature of each component must be able to operate without interfering with normal system operations and should adhere to modern web architectures, otherwise modification to communication flows may be needed.

Reporting modules as set up via the reports icon 504 can be utilized to configure what is displayed by the GUI such that a provider can monitor the success of each campaign. By selecting the reports icon 504, an administrator can configure what reports are generated and how they are presented to a provider. Each custom report can be associated with a particular provider campaign. When a provider account is created in the reporting module, the availability of and access to the reports can be restricted to a select few within the provider's organization. Interactive tools can be selected by an administrator to create near-real-time dynamic reports. A dynamic report can operate like, or similar to, a liquid read-only open-source toolset provided by Shopify. Dozens of report configurations and widgets can be included as part of the reporting module. The disclosed system and method can support e-commerce of hardware, software, digital goods, various services, and/or donations. As referred to herein, donation to a non-profit organization is considered a “digital good,” Types of goods and/or service provided by the disclosed system, could also be referred to as a “Product,” “Membership,” “Contribution,” and/or “Donation.”

Via the setup/configuration 510 and website widgets icon 506, payment widgets can be selected and set up by an administrator that are executable by the CID. Such widgets can take the form of a bare field, a slider, selectable buttons, and/or a selectable dropdown menu. “Amount” fields or menus can be provided and displayed by the CID that allow the consumer to enter a payment amount and allow a consumer to enter an amount that varies from a standard amount suggest on the CID display. An administrator can add text to accompany the amount field or menu to show the amount or percent the consumer is saving as compared to a different transaction. Such text can increase consumer satisfaction and can describe various membership tiers or subscription levels, i.e. “Purchase a one year membership for $45.”

In some embodiments, a consumer can select an option to set up a payment plan or set up recurring payments. The exact operation of reoccurring payments is often dependent upon the abilities of the payment gateway provider to accept and process such payments. The system can allow the consumer to select the frequency, period, or schedule for recurring payments in different increments such as weekly, monthly, quarterly, bi-annual, and/or annually. The disclosed system provides a robust connection to payment gateways and successful transactions with the payment gateways. Due to the sensitive nature of payments gateways and payment generally, dynamic coding is not preferred to set up a gateway configuration. The disclosed system can utilize a hardened module with minimal control functions. Some of the gateway processors or systems supported by the disclosed system and method include: Stripe, Braintree Payments/PayPal and Salt Payments (formerly Admeris). However, any payment gateways and its corresponding processes can be made to work with the disclosed embodiments. It is preferred that the payment gateway have a downstream split settlement option to simplify accounting procedures.

Supported payment gateway interaction models can be configured from the GUI 500 which typically consists of HTTP transparent redirects or newer tokenized interactions. The disclosed embodiments operate such that no sensitive consumer related payment instrument data resides on servers other than those servers operated by financial institutions, even ephemerally. In addition, the disclosed system can support WorldPay, First Data North platform, Heartland Payment Systems, Chase Salem Platform, Merchant E-Solutions, T-Sys, Vital, and Visanet.

Some of the disclosed embodiments efficiently process split settlements to provide a scalable business model. Split settlement operations provide the ability of the system to charge service fees of various third-party facilitators and payment processors at the time of payment where these fees are transparently collected by the service provider without any visibility to the end user. Such a system allows for the fees to be separated from the main hinds or proceeds such that the fees and funds can be automatically deposited in the corresponding accounts. It is preferred that the merchant identifier on the consumers transaction account records, such as a credit card statement, not show the details of the split transaction such as to cause a consumer to question the charge for various fees. Split settlement configuration is a three-part process. First, the system and method should encapsulate the configurations; second, the gateway and payment processor should support transparent split a settlement; and third, the provider/merchant should opt-in to authorize payment service provider (payment processor) which will charge on the provider's behalf.

The embodiments can also transparently process chargebacks and returns for split settlements. The disclosed system and method provides for the requirement above and in addition has tools that allow a merchant opt-in and provide the needed authorization to complete a transaction. If the disclosed system cannot be set up with split payments, providers: must handle additional administrative back-office issues and should have enough transactional volume to support the invoicing and accounting time and costs needed to accurately manage the fee collection and tracking. Thus it is desired that payment gateways and payment processor who support the disclosed system comply with a robust tokenized architecture and have adequate provisions for streamlined split settlement.

Part of split settlement operations is a merchant fee system and configuration. In order to allow fixed amount or percentage based fees to be charged to individual or groups of merchants by a sales organization, the fee structures should be easy to set-up and assigned according to the nature of the sales arrangement. Such an arrangement is typically based on expected sales volumes as an offset to set-up costs, etc. The disclosed system and method allows for independent sales organizations (ISOs) to specify fees in set amounts or percentages and have those fees assigned to the ISO's merchants. Specified fees may be applied to portfolios or individual organization.

The disclosed system and method supports e-commerce product/service catalogs and the online purchase of products and services. The disclosed system and method provides for a user interface with streamlined functionality which makes it easy for a consumer to purchase a single product/service or related products/services on handsets with limited user interface (UI) space and functionality. The disclosed system and method also accommodates fulfillment of tax aspects per their dependency on the provider's requirement and needs. Thus, appropriate levels of dynamic adapters are available as the transactional hooks to link in to inventory, tax, and fulfillment systems. The disclosed system and method provides very similar operations regardless if the CID is a smartphone, mobile phone, tablet, laptop, or desktop computer. Additional parts of the system include receipt service, hosting considerations, cloud computing, database considerations (SQL, NoSQL), caching, high availability considerations, fault-tolerance considerations, third-party service integrations, performance monitoring, log monitoring, error identification and resolution, technical support, sales support, and related products.

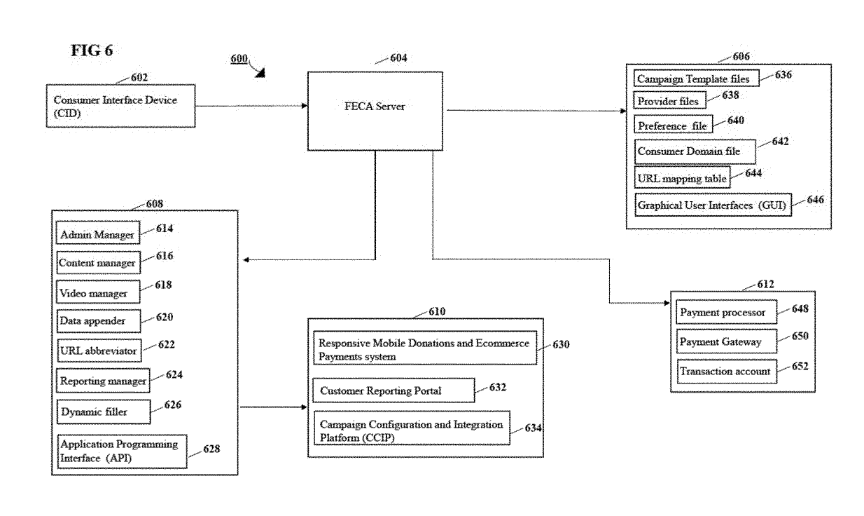

FIG. 6 provides a block diagram 600 depicting the CID 602 in communication with FECA server 604 which can receive a communication from CID 602 (having a transaction identifier) where the FECA server can call various software modules 608 that can access various data files 606 and can also access financial systems 610 using the software modules 608 and data files 606. Per the descriptions above, a consumer can see or receive a short code or a keyword and reply to it using CID 602 Which sends a communication to the FECA server 604. According to some embodiments, a consumer/donor/buyer using a CID 602 can reply by selecting a short code link which can be forwarded by a carrier in cooperation with a shod: code provider to connect the CID 602 with FECA server 604. The FECA server can call various application programming interfaces (APIs) 608 which when executed by FECA server 604 using the contents of the communication, can link the consumer's communication to a particular campaign template 636. The template 636 associated with each providers campaign can govern the parameters and data used to complete the detailed transaction with the CID 602, The template chosen can be based on, among other things, the short link or keyword to which the consumer has replied. API 608/708 can retrieve the desired template(s) and consumer data associated with the CID 602 and short link in response and can generate a URL to be, sent back to the CID 602, Prior to the FECA sewer sending the URL link back to CID 602, the URL abbreviator 622 can shorten, abbreviate, compress, or reconfigure the URL to reduce the number of characters in the original URL such that the shortened. URL can be sent to the CID 602 via a messaging system.

Messaging systems such as a Short Messaging Service (SMS) and a Multimedia Messaging Service (MMS) are limited in various ways such as how many character these services can process and transmit and shortening the number of characters in the originally generated URL allows virtually any URL to be transmitted via a messaging service or system by regenerating the original URL when necessary. Many different APIs 608 can be invoked by the FECA server to perform many different functions, such as generating URL mapping table which can provide look up functions, mapping functions, and linking functions. Such tables can be utilized to regenerate the original URL from the abbreviated URL. APIs 608 can map data fields communicate by the CID 602 into the selected template as defined by the provider who can set up and configure the system using an administration manager 614 which can further utilize graphical user interfaces (GUI) 646 to provide an efficient visual interface to set up and configure the system. API's 610 can provide many different features and function to include a Campaign Configuration and Integration Platform (CCIP) 634, a Customer Reporting Portal (CRP) 632, and Responsive Mobile Donations and Ecommerce Payments System (ECOM) 630. The CCIP 634, Reporting Portal 632, and ECOM 630 can comprise the core of the processes and subsystems of the API platform 610.

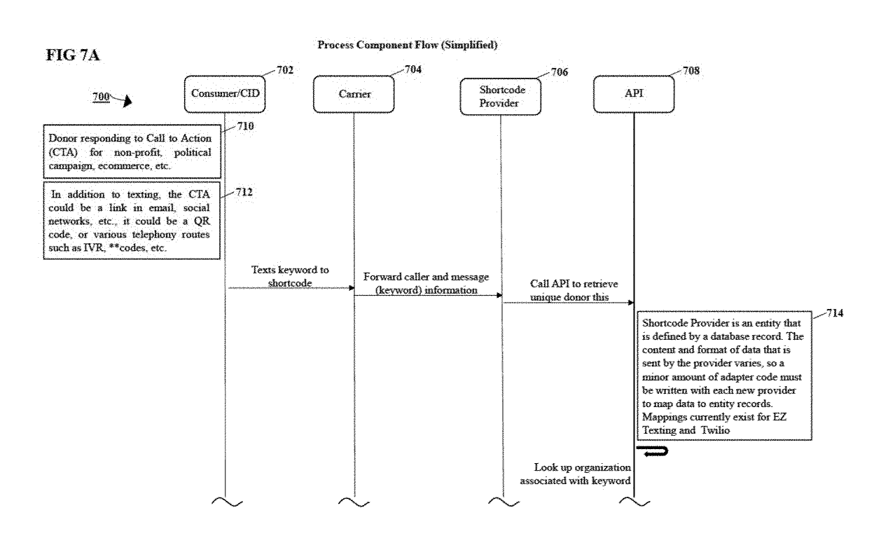

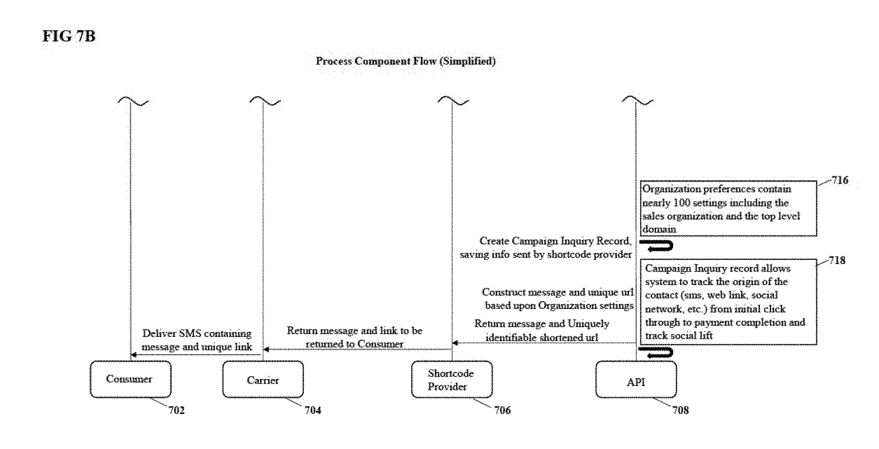

In some embodiments, the chain of communication disclosed in FIGS. 7A-B which culminates in a URL or hyperlink that is received by CID 602 can be viewed as the entry point or precursor to the disclosed method and system. Thus, the SMS interaction depicted in FIGS. 7A-B is one method or mechanism for generating a link that can be accessed via or through a SMS or MMS text message to capture a response from a CID 602. However, other arrangements such as links sent via email, social network postings, barcodes, QR codes, snapchat, twitter, etc,, could also be utilized as an entry point to the system. While standard linking from webpage to webpage is known and understood in the art, the system and methods disclosed use codes responded to using a messaging system (SMS and/or MMS) where the response is utilized to configure the transaction and it can be appreciated that such a configuration follows a different interaction paradigm than that of using a browser with selectable hyperlinks.

For example, offers provided via webpages hyperlinks do not have sufficient information and detail for a consumer to complete a transaction and thus hyperlinks webpages cannot be used by themselves to effectuate the transactions disclosed herein. Some embodiments include a SMS Provider Domain file 638 that can associate a provider with keywords or short codes and the provider's country of origin, organizational name, contact information, and various other data such as the provider's transaction configurations and preferred templates. Such a provider specific file approach allows for the efficient addition of new provider campaigns by copying, renaming, and making a few adjustments to existing provider files to create a new provider domain object file. This is beneficial because providers with similar business models tend to require very similar system operation to achieve substantially similar results.

It can be appreciated that to set up a new provider account a Provider Domain Object file template in the Campaign Template Files 636 can be “cloned” then tailored with minor modification to allow for the efficient addition of new providers or new profiles. Such a process can minimize set up time and any learning curve associated with a new campaign or a new provider. The amount of set up time, however, will be dependent upon each new provider's content, business model, operational parameters, and customization requests. The disclosed embodiments operate efficiently with services that utilize a REST-based API call in response to an event. For example, a REST-based API 628 can be called in response to the reception from a messaging system having a short code or configured keyword. In some embodiments, a dynamic adapter utility (or template filler) 626 can be utilized to place data that is received in transmissions into provider templates by make one-to-one field mappings or by parsing received data to place data in the proper fields in the template. It may be necessary in some cases to call an API adapter layer that can extract data from multiple communications and from multiple places to generate the proper data for each data field required or desired by the system. Such adaptive layers and calls can be utilized to accommodate anomalies such as field mapping differences and the parsing of data into various fields to populate a template. In addition, adapters requiring more complex data mapping function can be easily programmed, added, and called by the FECA server as required by new provider's campaigns, templates, protocols, and data structures.

In some embodiments, a Platform API 628 can be called to create a campaign inquiry record file which can be stored in the consumer domain file 642. The inquiry record file can effectively mark or tag caller/consumer communications such that each consumer activity can be tracked and logged throughout the entire process at the application level. As part of the tracking log, the carrier 606 can operate an API having the consumer's phone number associated with each CID response and customer data. Thus, if a particular customer has had previous transactions and communications with the disclosed system 600, the system can immediately identify the customer as a return customer and populate a template with existing data without having to request data and convert received data into a proper format to fill a template with the required data.

The disclosed system can call many different adapter pattern processes which can extract one or more data fields received via API calls and can map the extracted data into the desired fields in the newly created user data file. Multiple dynamic adapters can be configured via various system configurations. One such API that can be utilized is referred to herein as a Phone Lookup API service. Responses to API's can cost from 1-3 cents per request depending upon how much data is requested and how much data is returned and this cost can be entered into the consumer domain file and passed on to the provider. The data appender 620 can be an optional feature that can be utilized by a provider. In some embodiments, additional data such as e-mail addresses and social network account identifiers, such as Twitter, Facebook, and Instagram identifiers could be utilized in lieu of a phone number to facilitate data entries into the system. After the consumer data file is generated and stored, a campaign inquiry and tracking record can be generated and saved.

In some embodiments, a special or unique URL can be generated for each transaction and the unique URL can be stored as part of the campaign inquiry record. The campaign inquiry record can also include the abbreviated URL such that the abbreviated URL can be mapped back to the original unique URL It is desired to manage and limit the number of characters of the custom URL to less than the maximum amount of characters (character limit) allowable via a messaging system specification or infrastructure. In some embodiments, the shortened URL can be a pre-determined URL associated with a known URL, such as a “bitly” shortened Bitly is a third-party provider whose services can be viewed at https://bitly.com/. The disclosed URL abbreviator 622 can also utilize a top-level domain address of the providers and/or their parent organization which would allow the consumer to recognize the offer as and offer originating from a known trusted provider or that the communication is from a trusted source or is associated with a known brand. The URL abbreviator 622 provides an important function as without limiting the number of characters that may be returned in an SMS message or social network posting, a communication error can result.

Referring to FIG. 7A, in some embodiments, a math function can be applied to the unique URL to generate the shorten ULR. The shortened URL can be effectively communicated between the consumer 702 and their CID and the consumer's carrier 704 where the consumer's communication can ultimately be sent from the CID to the consumer's carrier via a SMS system. Per block 710, the consumer can be a donor who responds to a call to action to donate time to a non-profit cause or a for profit cause. In addition to texting, the call to action for the consumer could be done utilizing an e-mail link or published via a social network or some other means of getting provider content out to the public or potential consumers as is shown by block 712. The CID 702 can send a communication to the carrier who can't access a short code provider 706 who can make an API call to an API provider 708. As shown in block 714, the short code provider 706 can provide data based records, however, this data may need to be processed such that it can be written or mapped into a provider's template. An API can also look up which provider or organization is associated with the short code of keyword.

Referring to FIG. 7B, block 716 shows that after the response from the CID 702 is mapped to the proper provider/organization, the CID 702 can be associated with a top-level domain of the provider and the processing configuration that the identified provider has set up in the system. The disclosed arrangements can set up and store a campaign inquiry record file which can be utilized to identify the consumer. the CID 702, and the provider being accessed by the CID 702. The campaign inquiry record file can be utilized to link the communication to a particular source or impression and/or campaign publication based on what link the consumer saw and responded to. The campaign inquiry record can also assist in calling and provide additional features and functions based on a consumer's past and/or historical use of the system. If a consumer is making their first inquiry, the FECA server can send the consumer's phone number to various services who run API's 708 to retrieve details about the consumer. including their carrier, their plan, their account, and other associated data and return the data to the FECA server. The disclosed system and method can generate and populate a consumer data file for a consumer's first inquiry and populate the user data file with data retrieved via various sources. Generally, API 708 services that provide data associated with phone numbers do not guarantee or warrant accurate data based on a phone number inquiry thus it is desirable to obtain data from multiple sources and utilize the most accurate data available.

The API 708 can assist in facilitating a return transmission with a uniquely identifiable shortened URI Although a URL will often not map to a particular phone number associated with the CID 702 and the consumer 702 based on a consumer's selection of the shortened URL link, such a process can be strengthened or verified via an API 708. Therefore, the system can request the phone number from API 708 to fill this data field in the consumers data file. In addition to the selectable link, the disclosed system and method can transmit additional data using the messaging system. For example, the transmission can include text that supplements or supports the offer message and response message. The supporting text can be easily tailored and/or easily configurable by an administrator. The supporting text can have parameterized “hooks” to support the URL shortener function to allow it to operate properly with the customized text. The system can be configured to generate and transmit a default message to the CID 702 if no customized text or message is specified by an administrator. The communication with the shortened URL can be sent back to the CID 702 where the CID 702 can display the unique link to the consumer.

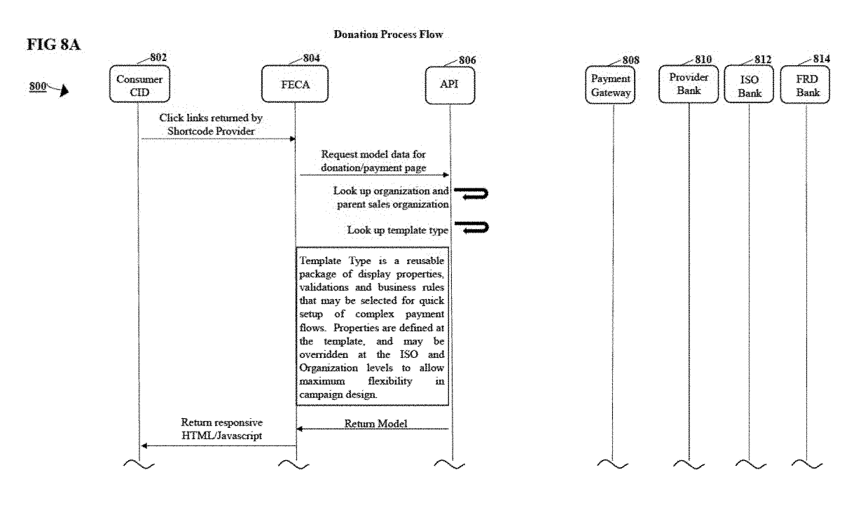

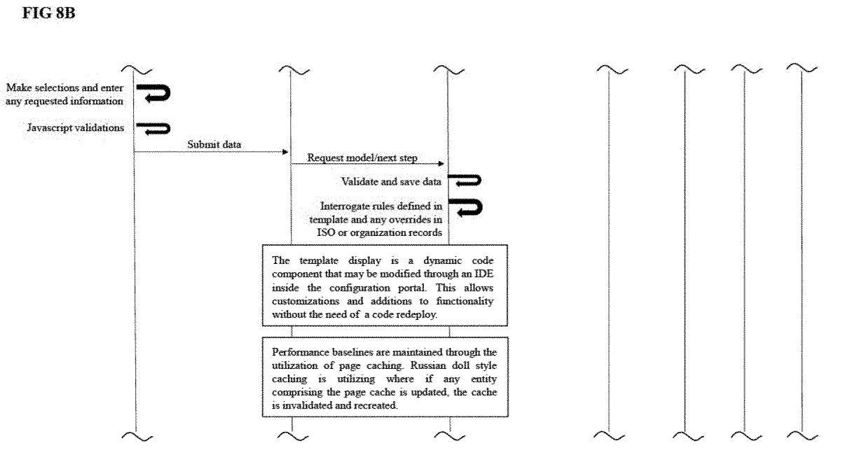

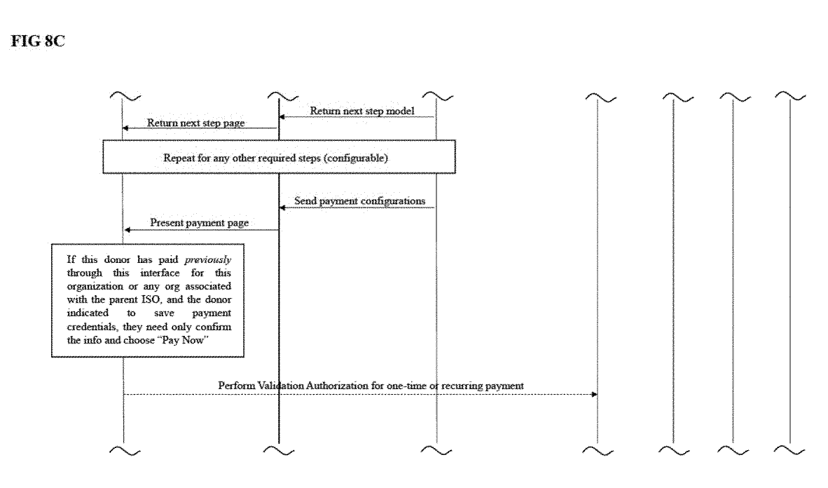

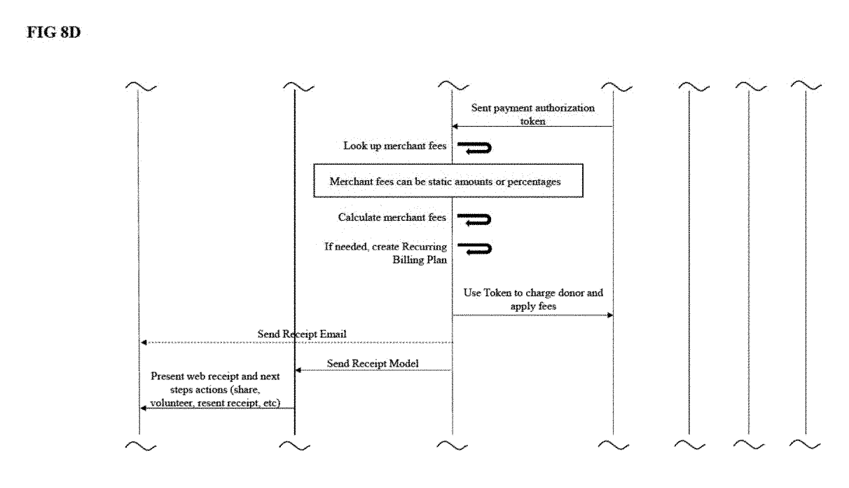

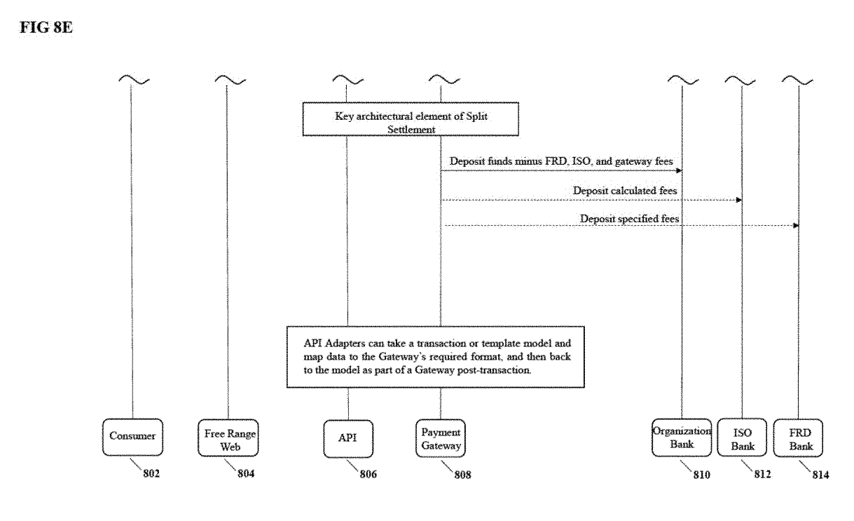

Referring to FIG. 8A, a more specific embodiment for operating the system to solicit and accept donations is depicted. As per FIGS. 7A and 7B, the CID 802 can communicate with FECA 804, API 806, Payment gateway 808, Financial organization/bank 810, ISO Bank 812, and FRD bank 814. The link selected by the consumer via the CID 802 will activate API 806 which can look up the responsible provider/organization and request. model data for the donation/payment page associated with the provider based on the return communication. The templates called by the API 806 can be a re-useable package of display properties or GUIs with associated business rules and complex yet robust payment flows. Although the properties and operations of the transactions are generally based on the template and its associated rules, such operations can be overridden at the ISO and organizational levels to allow for greater flexibility. The API 806 can return the business model or flow properties responsive to a HTML/JavaScript.

Referring to FIG. 8B, the consumer can initiate a reply based on the consumer's selection and can enter any requested information needed to complete the transaction and. JavaScripts can be validated. The CID can send or submit data back to the API which can request the next step of the process where the communication and the customer can be validated and the data can be saved. The API 806 can interrogate the rules that are defined by the selected template and make any necessary overrides based on, among other things, the consumer's financial providers. The template can be filled via dynamic code which can be modified through an IDE inside of a configuration portal. Such a configuration allows customization and additions to be made without the need to continually redeploy code to the system. Performance baselines can be maintained via the caching of pages. Russian doll type page caching can be utilized when page caching is updated where the cached page can be invalidated and recreated.

Referring to FIG. 8C, the API 806 can return a next step model to the CID 802 and this process can cycle until all of the data required from the consumer and CID is acquired by the system. Next, the API 806 can send payment configurations to the FECA 804 and the FECA 804 can send a payment data page that can be displayed by the CID 802. In this embodiment, if the consumer/donor has previously utilized the system and donated to the same provider or any entity associated with the parent independent sales organization (ISO) who processes electronic payments, the system can just confirm the transaction information and send a “Pay Now” link to the CID 802. Selection of the “Pay Now” link by a donor consumer will. send a validation authorization link for one time or reoccurring payments to payment gateway 808.

Referring to FIG. 8D, the payment gateway can send a payment authorization token to API 806 and, the API 806 can look up what merchant fees apply. Merchant fees from ISOs can be static amounts, or percentages of the amount of the transaction or a combination of both. API 806 can calculate the merchant fees associated with the current transaction and can access and update data related to a recurring billing plan. API 806 can then send a communication to the payment gateway 808 and the payment gateway 808 can use the token and associated information to charge the donor's transaction account and apply the fees according to the parameters of the defined transaction.

API 806 can send a receipt to the consumer/donor via e-mail, or text which can be displayed on the consumer/domes CID 802. API can also send a receipt model to FECA which in turn can send a receipt to the CID 802 with relevant instructions such as next steps or actions that the consumer/donor may be concerned with such as an invitation, when to appear to volunteer, or other related relevant data such as when a future event will occur.

Referring to FIG. 8E, the FECA 804 and the API 806 communicate the fee splitting arrangement which determines how much of the purchase or donation goes to the provider and how much goes to the financial transaction processors. Such information can be acquired from the payment gateway 808, and/or the provider's bank 810, and ISO bank 812, or in some cases from data stored as part of the template. An API 806 such as an adapter API can extract data from a transaction model or a template and put the data in a format that is compatible with the format required by the payment gateway 808.

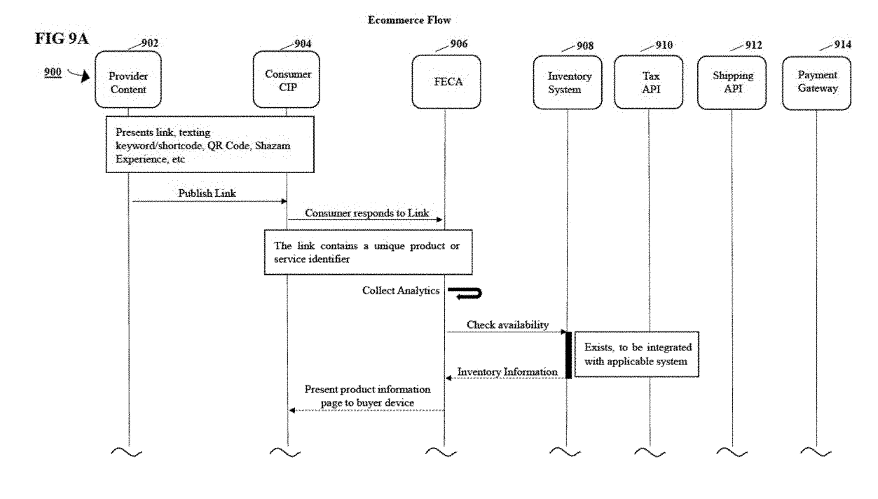

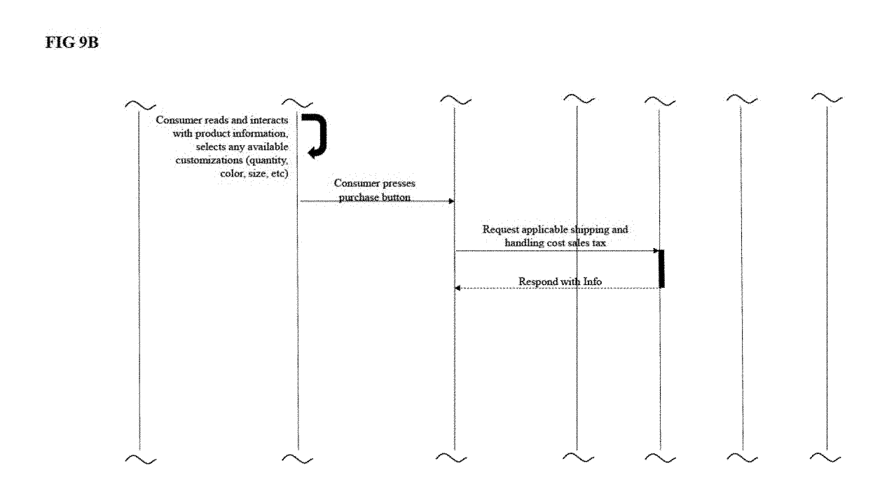

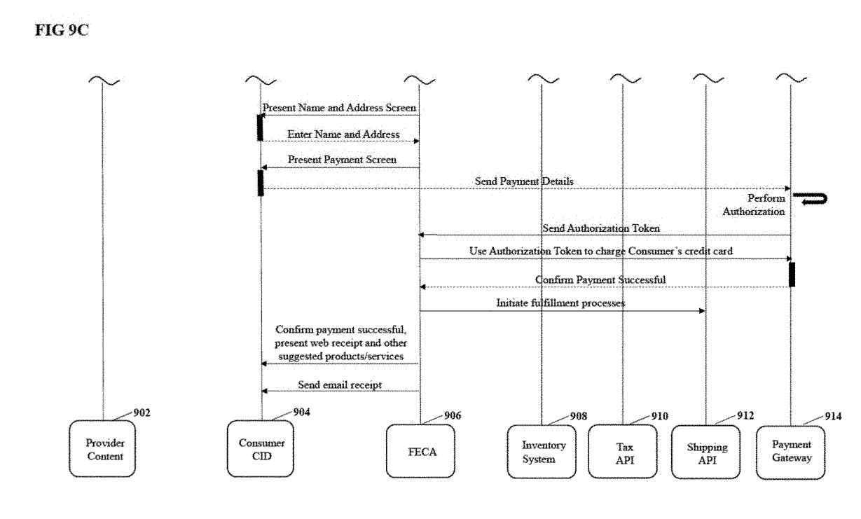

Referring to FIG. 9A, a more specific embodiment for operating the system to conduct an e-commerce transaction is depicted. In accordance with FIG. 9A, a provider 902 can publish advertising content having a linking mechanism where the link can be published by nearly any media outlet that can reach a consumer 904. The link can be a shortcode, a keyword, a QR code, a Shazam experience, etc. A consumer's response to the supplied link can be sent to the FECA 906 where the link can contain a unique product or service identifier based on a specific provider offering. The FECA 906 can collect analytics on the received link and can check inventory system 908 for the availability of the specific good or service associated with the published link. The FECA 906 can then send product information and other details about provider's offer to the customer via the CID.

Referring to FIG. 9B, the consumer can view and inter act with the provider's information and customize their order. The consumer 904 can then select a provider's offer via a CID by pressing a button, such as a “purchase button.” Based on such a response, the FECA in cooperation with a tax API 910 and a shipping API 912 can calculate sales tax and shipping costs, total the amount due, and return an invoice to the consumer 904.

Referring to FIG. 9C, the FECA 906 can send screens to be displayed by the CID where the consumer can enter their name and payment information. The FECA can receive such information and send payment details to payment gateway 914 which can authorize the transaction. The payment gateway 914 can send an authorization token to the FECA 906 which can use the authorization token to charge the consumers transaction account (i.e., credit card, debit card electronic check wire transfer, etc.) The payment gateway can communicate with the FECA 906 to confirm and verify the details of the transaction and to initiate the fulfillment process. The FECA 906 can then send a confirmation message the customer via the CID and also possibly send an e-mail confirmation.

Each software program described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet, or other networks. Such signal-bearing media, when carrying computer-readable instructions that direct the functions of the present invention, represent embodiments of the present invention.

It will be apparent to those skilled in the art having the benefit of this disclosure that the present invention contemplates methods, systems, and media for detecting fraudulent behavior dining an e-commerce (Internet commerce) session. It is understood that the form of the invention shown and described in the detailed description and the drawings are to be taken merely as examples. It is intended that the following claims be interpreted broadly to embrace. all the variations of the example embodiments disclosed.

While specific embodiments will be described below with reference to configurations of hardware and/or software, those skilled in the art will realize that embodiments of the present invention may advantageously be implemented with other substantially equivalent hardware and/or software systems. Aspects of the invention described herein may be stored or distributed on computer-readable media, including magnetic and optically readable and removable computer disks, as well as distributed electronically over the Internet or over other networks, including telecommunications networks. Data structures and transmission of data (including wireless transmission) particular to aspects of the invention are also encompassed within the scope of the invention.

What is clamed is:

1. A method for ad hoc electronic commerce between a consumer and a provider comprising:
storing provider data and consumer data at a marketing campaign server (MCS), the MCS associating a unique short code link (SCL) with a provider offer, the provider offer being sufficiently defined such that a consumer's response to the SCL provides a preliminary acceptance to the provider offer;
facilitating a transmission of the SCL to a consumer interface device (CID), the SCL displayable on the CID such that the consumer, via selection of the SCL can send an acceptance response to the provider offer;
receiving an acceptance to the offer at a front-end commerce application (FECA) server;
associating the received acceptance with the provider offer;
executing a set of rules and programming interfaces based on the acceptance to the provider offer, the set of programming interfaces executed by the FECA as defined by the provider;
transmitting a universal resource locator (URL) links to the consumer based on the consumer acceptance to the provider offer; and
receiving an acceptance response to the transmitted URL link to seamlessly bridging communication with the CID from a messaging service to an Internet Protocol network such that the consumer can authorize a financial transaction.

2. A method of claim 1, further comprising:
associating the CID with a transaction account at the MCS; and
pre-verifying a consumer's authority to access a transaction account based on a mobile device identifier associated with the CID without executing a consumer registration procedure.

3. The method of claim 1, further comprising reducing a number of characters in the URL link prior to transmission of the URL such that the URL link can be sent via a messaging system.

4. The method of claim 1, further comprising receiving an authorization request from the CID at a payment gateway to access a transaction account associated with the CID via the Internet Protocol based network.

5. The method of claim 1, further comprising automatically transmitting, by the FECA server, a fulfillment request to a fulfillment entity via the Internet Protocol based network, if a transaction account management server authenticates the request from the CID.

6. The method of claim 1 further comprising automatically transmitting by the FECA server a confirmation indication of an approved transaction to the CID, if the FECA server receives an affirmative response to the authorization request via the Internet Protocol based network from the transaction account management server, wherein the ad hoc nature of the transaction as facilitated by the FECA server offloads a consumer and their CID from having to associate and coordinate a solicitation with a transaction account, a verification entity, and a fulfillment entity and from having to locally download and execute an application from one of a payment gateway or a transaction account authorization entity on to the cm thereby minimizing the amount of time and interaction required to complete a transaction.

7. The method of claim 1, wherein the message service is one of a short message service and a multimedia message service.

8. The method of claim 1, further comprising facilitating an automated Internet Protocol based communication channel between the CID and at least one of a payment gateway and a transaction account authorization entity via the FECA based on a unique URL link.

9. The method of claim 1, further comprising locating a template associated with the SCL, querying third party data sources and populating data fields in the template using a one or more application programming interfaces.

10. The method of claim 1, wherein content associated the SCL includes at least one of an offer to donate, buy, sell, rent, lease, or giveaway a product or service where the offer includes at least one of a description of a use of funds received from the consumer, to include one of a non-profit effort, the shipping of a product, and the providing of a service.

11. A non-transitory computer-usable medium for facilitating a single purpose, ad-hoc transaction via at least two separate communications networks, said non-transitory computer-usable medium embodying computer program code operable on a server, said computer program code comprising computer executable instructions configured to:
store provider data and consumer data at a marketing campaign server (MCS), the MCS associating a unique short code link (SCL) with a provider offer, the provider offer being sufficiently defined such that a consumer's response to the SCL provides a preliminary acceptance to the provider's offer;
facilitate a transmission of the SCL to a consumer interface device (CID), the SCL accessible by the CID such that the consumer via selection of the SCL can send an acceptance response to the provider offer;
receive an acceptance to the provider offer at a front-end commerce application (FECA) server;
associate the received acceptance with the provider offer:
execute a set of rules the provider has associated with the provider's offer:
associate a unique selectable universal resource locator (URL) link with the provider offer;
facilitate transmission of the unique selectable URL to the CID to seamlessly bridge the CID communications from the messaging service to an Internet Protocol network; and
receiving an acceptance response to the transmitted URL such that the consumer can authorize a payment gateway to complete a transaction.

12. The non-transitory computer-usable medium of claim 11, wherein said computer program code further comprises computer executable instructions configured to:
associate the CID with a transaction account at the MCS; and
pre-verify a consumer's authority to access a transaction account based on a mobile device identifier associated with the CID without executing a consumer registration procedure.

13. The non-transitory computer-usable medium of claim 11, wherein said computer program code further comprises computer executable instructions configured to reduce a number of characters in the URL link prior to transmission of the URL such that the URL link can be sent via a messaging system.

14. The non-transitory computer-usable medium of claim 11, wherein said computer program code further comprises computer executable instructions configured to receive an authorization request from the CID at a payment gateway to access a transaction account associated with the CID via the Internet Protocol based network.

15. The non-transitory computer-usable medium of claim 11, wherein said computer program code further comprises computer executable instructions configured to automatically transmit by the FECA server a confirmation indication of an approved transaction to the CID, if the FECA server receives an affirmative response to the authorization request via the Internet Protocol based network from the transaction account management server, wherein the ad hoc nature of the transaction as facilitated by the FECA server offloads a consumer and their CID from having to associate and coordinate a solicitation with a transaction account, a verification entity, and a fulfillment entity and from having to locally download and execute an application from one of a payment gateway or a transaction account authorization entity on to the CID thereby minimizing the amount of time and interaction required to complete a transaction.

16. A method for ad hoc electronic commerce between a consumer and a provider comprising:
configuring by a provider a campaign for sending a consumer content data via a marketing campaign server (MCS), the campaign having at least one link, a business rules template, and a sufficiently defined offer such that a consumer's response to the offer constitutes a preliminary acceptance to enter into a transaction;
facilitating a transmission of the campaign to a consumer interface device (CID), the content displayable on the CID such that the consumer, via selection of the at least one link, can send a preliminary acceptance response to the provider offer;
receiving a reply to the at least one link as an acceptance to the provider offer at a front-end commerce application server;
executing a set of rules and programming interfaces based on the acceptance to the provider offer, the configured business rules template, and the set of programming, interfaces executed by the FECA as defined by the provider;
transmitting a universal resource locator (URL) link to the consumer based on the. consumer acceptance to the provider offer; and
receiving an acceptance response to the transmitted URL link to seamlessly bridging communication with the CID from a messaging service to an Internet Protocol network such that the consumer can authorize a financial transaction as offered by the configured campaign.

17. A method of claim 16, further comprising:
associating the CID with a transaction account at the MCS; and
pre-verifying a consumer's authority to access a transaction account based on a mobile device identifier associated with the CID without executing a consumer registration procedure,

18. The method of claim 16, further comprising reducing a number of characters in the URL link prior to transmission of the URL such that the URL link can be sent via a messaging system.

19. The method of claim 16, further comprising receiving an authorization request from the CID at a payment gateway to access a transaction account associated with the CID via the Internet Protocol based network.

20. The method of claim 1 further comprising automatically transmitting by the FECA server a confirmation indication of an approved transaction to the CID, if the FECA server receives an affirmative response to the authorization request via the Internet Protocol based network from the transaction account management server, wherein the ad hoc nature of the transaction as facilitated by the FECA server offloads a consumer and their CID from having to associate and coordinate a solicitation with a transaction account, a verification entity, and a fulfillment entity and from having to locally download and execute an application from one of a payment gateway or a transaction account authorization entity on to the CID thereby minimizing the amount of time and interaction required to complete a transaction.
